(19) United States
(12) Patent Application Publication
(10) Pub. No.: US 2005/0203821 A1
(43) Pub. Date: Sep. 15, 2005

(54) Integrated procurement knowledge tools

(76) Inventors: Paula Petersen, Roseville, CA (US); Peter Williams, San Jose, CA (US); Sarah Griffin, Roseville, CA (US); Steve Butler, Battle Ground, WA (US); Christine Lorentz, Tigard, OR (US); Jay Perrizo, Monmouth, OR (US); Sandy Allen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/795,346

(22) Filed: Mar. 9, 2004

(51) Int. Cl. G06F 17/60

(52) U.S. Cl. 705/36

(57) ABSTRACT

A method of, system for, and computer-readable medium containing instructions for managing procurement of a good or service for an enterprise are described. A centralized, network-accessible repository for supplier and contract information of the enterprise is provided, as well as a mechanism for identifying suppliers in the supplier and contract information repository, storage of financial information related to enterprise procurement, and a repository for supplier performance evaluation of suppliers in the supplier and contract information repository. A single interface for accessing the supplier and contract information repository, supplier identification mechanism, enterprise procurement-related financial information, and supplier performance evaluations is provided to a user.

### FIELD OF THE INVENTION

The present invention relates to contract and supplier management.

### BACKGROUND

Businesses contract with suppliers for goods and services. Large businesses contract with numerous suppliers for a multitude of goods and services. The goods and services are often critical for maintaining the day-to-day operation of the business. Effective management of the contracts and suppliers of a business results in savings for the business.

It is known in the art to manually manage contract information and supplier information through the use of physical files, papers, and reports. However, more complicated and more numerous contracts, as well as more suppliers, requires increased efficiency in the organization and access of the information related to the suppliers, their associated bids, and any associated contracts. Further, distributed businesses may contract with multiple suppliers at differing locations for similar, or the same, goods or services. Additionally, location-independent access to the information is important for distributed business concerns.

Prior approaches in the marketplace have failed because they failed to deliver a fully integrated supplier management solution. Other attempted solutions have delivered only partial solutions to supplier management typically focused solely on contract management.

### SUMMARY

A system according to an embodiment of the present invention is designed to provide a comprehensive contract and supplier management tool for good and service procurement of an enterprise. The system includes an information database of suppliers and contracts used by good and service procurement personnel. The Supplier/Contract database provides access to summary level business control and decision data with drill down functionality to access the detail documents for supporting the management of purchasing and contracting with suppliers.

A method of, system for, and computer-readable medium containing instructions for managing procurement of a good or service for an enterprise are described below. A centralized, network-accessible repository for supplier and contract information of the enterprise is provided, as well as a mechanism for identifying suppliers in the supplier and contract information repository, storage of financial information related to enterprise procurement, and a repository for supplier performance evaluation of suppliers in the supplier and contract information repository. A single interface for accessing the supplier and contract information repository, supplier identification mechanism, enterprise procurement-related financial information, and supplier performance evaluations is provided to a user.

An integrated approach according to an embodiment of the present invention embraces the entire strategic procurement process lifecycle, from data analysis through to supplier evaluation. The integrated approach also creates a single repository for all supplier documents creating a ‘virtual’ file cabinet for users around the world to use.

Still other advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram depicting a procurement workbench according to an embodiment of the present invention;

FIG. 2 is a high level block diagram of a portion of the procurement workbench 100 of FIG. 1;

FIG. 3 is an entity relationship diagram of Contract/Supplier (C/S) database 102 of FIG. 1;

FIGS. 4A through 4LL depict tables included in C/S database 102;

FIG. 5 is an exemplary graphical user interface (GUI) 500 usable in conjunction with an embodiment of the procurement workbench 100 according to an embodiment of the present invention;

FIG. 6 is a close up view of the navigation bar 502 of the GUI 500 of FIG. 5;

FIGS. 7-59 are screens according to an embodiment of the present invention;

FIG. 60 is a high level diagram of hardware components and a flow of data between the various hardware components of an exemplary embodiment according to the present invention;

FIG. 61 is a high level block diagram of a three tier view of an exemplary embodiment according to the present invention; and

FIG. 62 is a block diagram depicting an exemplary computer or user device upon which an embodiment of the invention may be implemented.

### DETAILED DESCRIPTION

The term procurement workbench refers to a broad set of web-based, integrated tools specifically designed to support a user, i.e., a procurement professional, through the strategic procurement process lifecycle. The workbench introduces the Contract/Supplier Database and the Document Library with links to the Supplier Reference Server, Enterprise Directory, Total Buy, and the Commodity Coding Tool. The user-friendly design of the Workbench maintains a look and feel consistent with a business' web portal. Additional tools support the procurement community in fulfilling their defined business objective of purchasing the best products and/or services for the business at the best possible price.

This new web-based system provides some of the following benefits:
Ensures global data availability and enhanced data integrity;
Provides visibility to the actual contract regardless of location;
Seamlessly integrates the supplier/contract database and the document library for the user;
Reduces costs through leveraging of existing contracts and documents, and eliminates redundant activity;
Automates alerts and triggers, such as when a contract is due to expire;
Provides enhanced search and reporting capabilities;
Utilizes industry standards, such as the UN/SPSC Commodity Codes;
Meets global good and service procurement user needs for both commodity and geographic audiences, and integrates them into the portal;
Empowers procurement professionals to make informed decisions by providing the real time global view of procurement activity information; and
Improves the Total Employee Experience through interface ease of use.

The Workbench provides some of the following key functions:
Provides a central location on the Web for viewing summary supplier and contract information for all contracts administered by procurement personnel;
Provides a mechanism for the assigrnent and maintenance of “Tier Code” and “Primary Commodity Code” at the supplier level;
Provides an environment for the capture and maintenance of additional supplier management information. This information is associated with the ongoing review and maintenance of procurement personnel's contractual supplier relationships. It includes information on TQRDCE, Insurance, Bid forms, and supplier risk evaluations;
Provides spend data from Total Buy;
Provides built-in custom developed reporting tools and data administrators can furnish additional customer reports;
Associates contract data with a single listing of a supplier for better overall visibility and management;
Provides easy access to contract information and automates most routine contract management monitoring tasks;
Enables strategic supplier management with shared supplier information and documents; and
Provides global access and supports global management of purchasing and contracting with suppliers through business control and decision data.

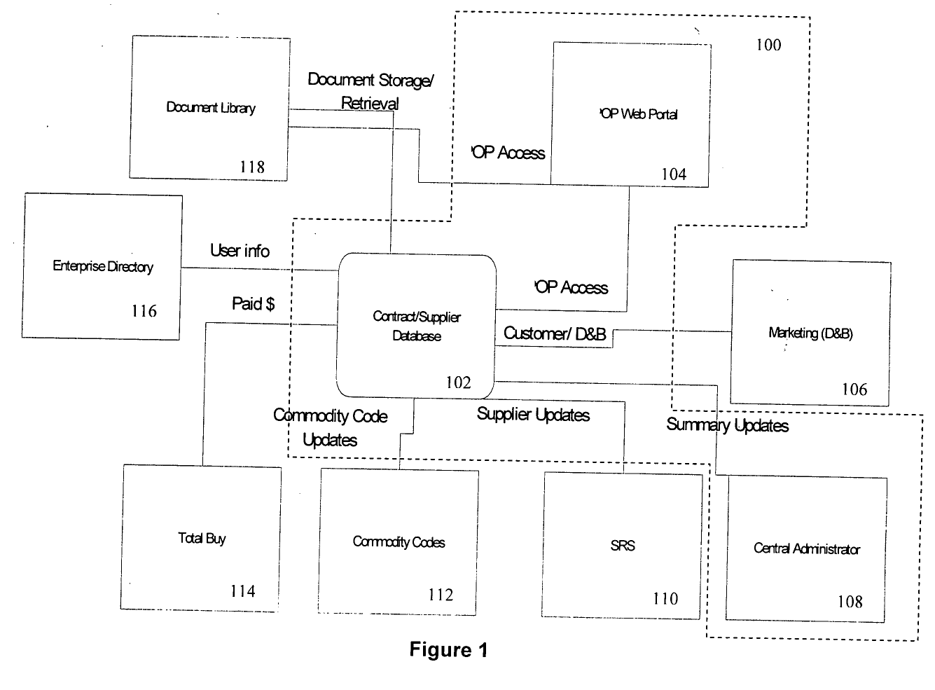

FIG. 1 is a high level block diagram depicting a procurement workbench 100 (dashed line) including a contract/supplier database 102, used in conjunction with an embodiment of the procurement workbench according to the present invention, in context with additional objects acting as sources and sinks of information. C/S database 102 is a central repository and source for information received/transmitted from/to the additional objects. The additional objects include, a good and service procurement web portal object 104, a marketing object 106, a central administrator object 108, a supplier reference system (SRS) object 110, a commodity codes object 112, a total buy object 114, an enterprise directory object 116, and a document library object 118. Procurement workbench 100 integrates access to the information provided by the additional objects and the information stored in C/S database 102.

Good and service procurement web portal object 104 enables user access to the procurement workbench 100 of the present invention in the form of a front end graphical user interface (GUI) described in detail below. Marketing object 106 enables access to marketing information, e.g., Dunn & Bradstreet reports and information. Central administrator object 108 enables administrator users access to C/S database 100 for administrative operations relating to the C/S database.

SRS object 110 enables access to supplier information, e.g., supplier identifier, supplier name, address, business codes and other supplier-related information. Commodity code object 112 enables access to commodity code information for classifying products and services. Total buy object 114 enables access to financial data relating to amount spent on a supplier or commodity, i.e., a particular good or service offered by a supplier. Enterprise directory object 116 enables access to human resource information and authentication/authorization information for users of the procurement workbench 100. Document library object 118 enables storage and retrieval of documents.

External Objects

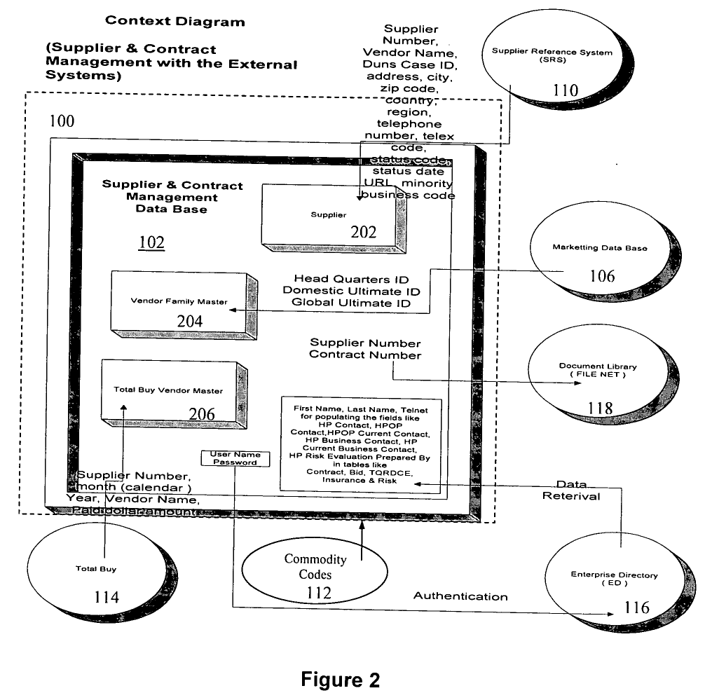

FIG. 2 is a high level block diagram of a portion of the procurement workbench 100 of FIG. 1 depicting additional detail within C/S database 102 and identifying external systems with which procurement workbench 100 interacts. C/S database 102 includes a supplier object 202, a vendor family master object 204, and a total buy vendor master 206. Workbench 100 interacts with external objects including SRS object 110, marketing object 106, document library object 118, enterprise directory object 116, commodity codes object 112, and total buy object 114. The external objects may also be referred to as external systems.

Sets of automated tools (one for each external object) are integrated as part of workbench 100, in order to automate the process of interfacing with the external object. The automated external interface tools are scripts, written using a combination of available scripting facilities. Such scripts may include shell, perl, sed, awk, and other script mechanisms. Each of the external interface tools includes a configuration file, one file for each external interface. Each of the external objects is described in more detail below.

Marketing Object

The Dunn and Bradstreet (D&B) Hierarchy model is used in the Workbench 100 to allow for viewing supplier information in a variety of atomic or consolidated views based upon a supplier's family relationship with other suppliers that are based upon financial ownership or corporate structure.

Dunn and Bradstreet has a working family tree utilizing the unique D&B ID number, assigned to each business location. This model allows for the association of branch offices to a headquarters, and subsidiaries to a parent, with each of these aligning with a domestic ultimate, and finally a global ultimate entity. This information is available through the Marketing Global database or through a direct link to Dunn and Bradstreet.

The Workbench 100 has established a dependency on the assignment of an SRS ID as a key field for the association of all supplier data elements to be retained in the Supplier and Contract/Document Library database. In turn, the dependency enables the linkage of this information to information generated from future transactional systems, pay systems, and tracking and reporting systems.

The information from the D&B Hierarchy model is used in the Workbench 100 to enable the viewing of supplier information in a variety of atomic or consolidated views based upon a supplier's family relationship with other suppliers, financial ownership, or corporate structure.

SRS Object

The existing minority business codes are overlaid by the SRS codes for existing suppliers. The status of all the suppliers is converted to pending, active, inactive or blocked and migrates only the first contact address of the supplier contact. The family information for all existing suppliers needs to be updated. Data pertaining to the new SRS suppliers for non-existing parents is added to SRS and supplier contract database. All parent suppliers are associated with children to display hierarchy. All the data is downloaded from the existing (in use) database into a flat file, which is modified according to the formats in the supplier contract database and uploaded to the same.

SRS stores information related to the suppliers. In Workbench 100, it is necessary to have the SRS data available locally. Workbench 100 revolves around the Supplier's data. Therefore, it is required that the integration of SRS to Workbench 100 be in a flawless manner. SRS data is obtained in XML format from SRS system. The SRS data is parsed and then loaded to the tables. SRS will send the incremental data every 10 minutes.

The Workbench application has an automated process for continually processing XML data files from SRS, e.g., a Cron Job scheduled every 15 minutes in the HP UNIX system processes the XML data files from SRS. In a particular embodiment, the SRS system transfers, e.g., via file transfer protocol (ftp), the incremental data files to the system according to the present invention in the specified directory. A predefined script checks the directory, reads the data files, and loads it to the Workbench tables.

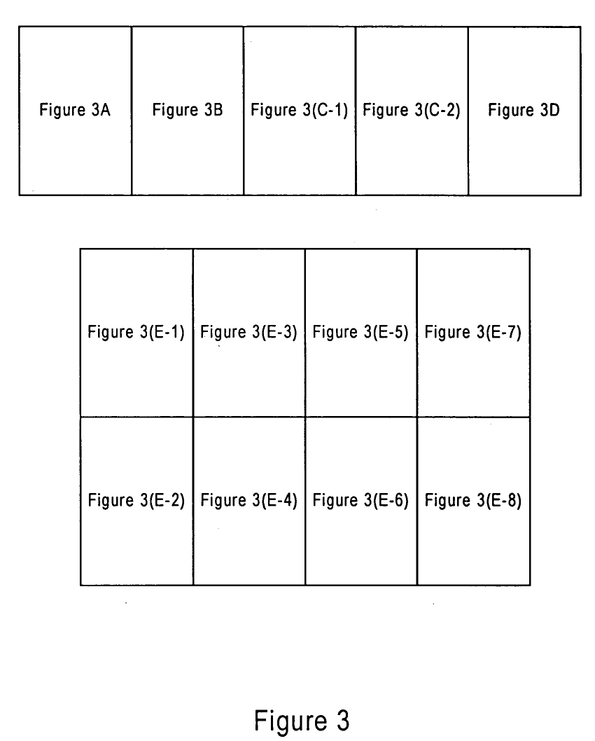

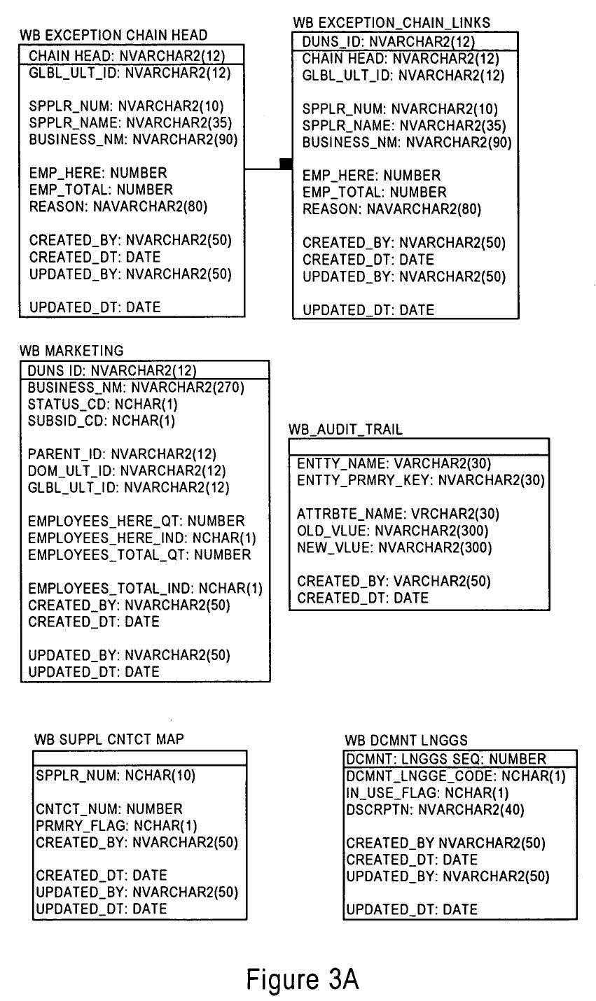

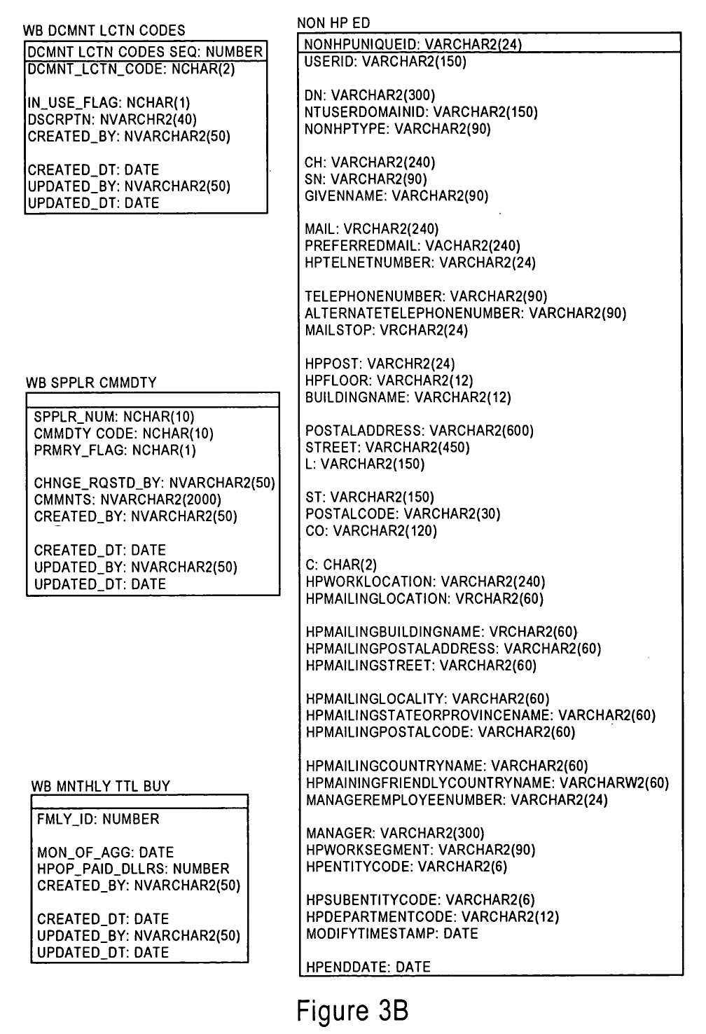

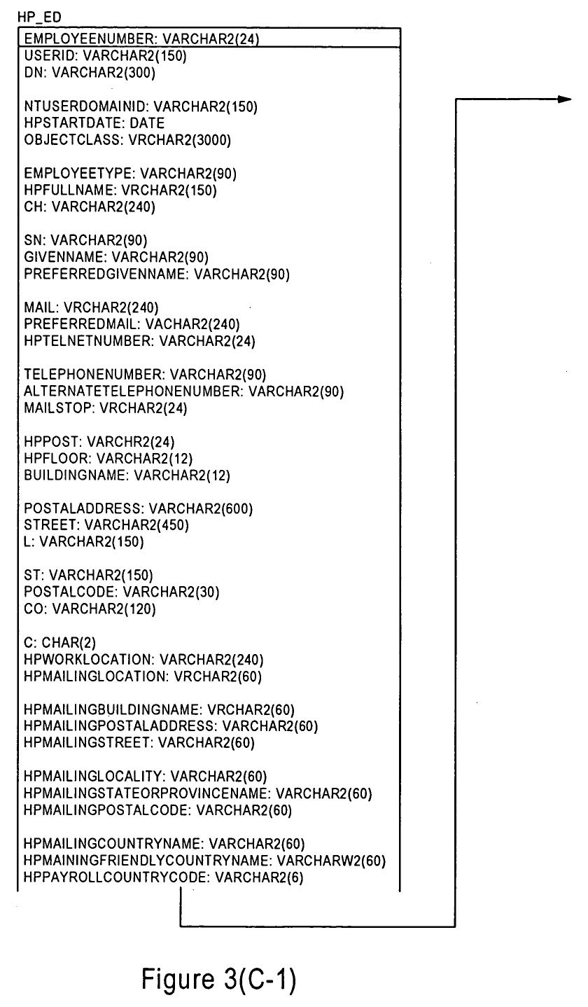

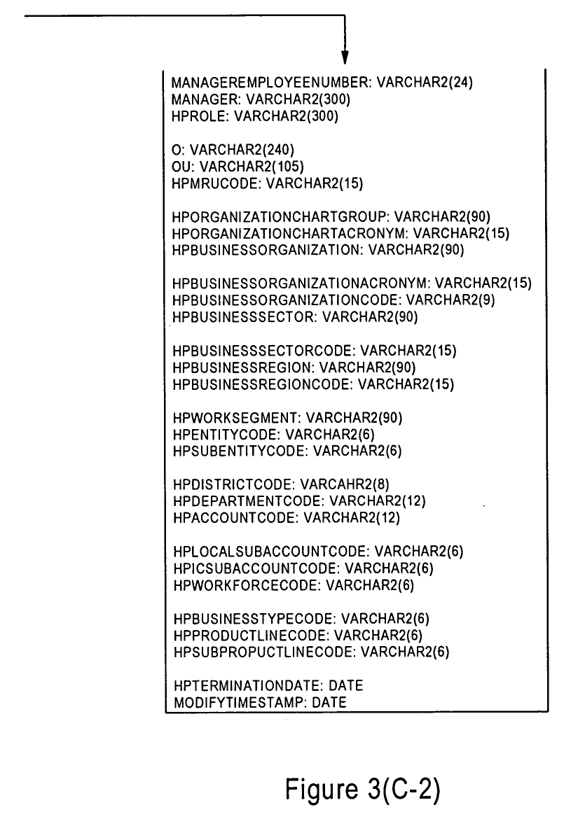

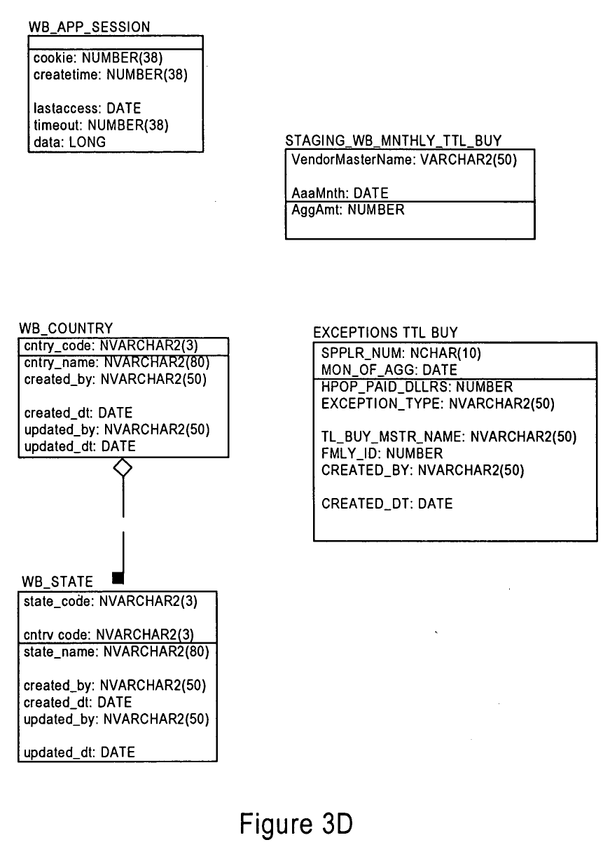

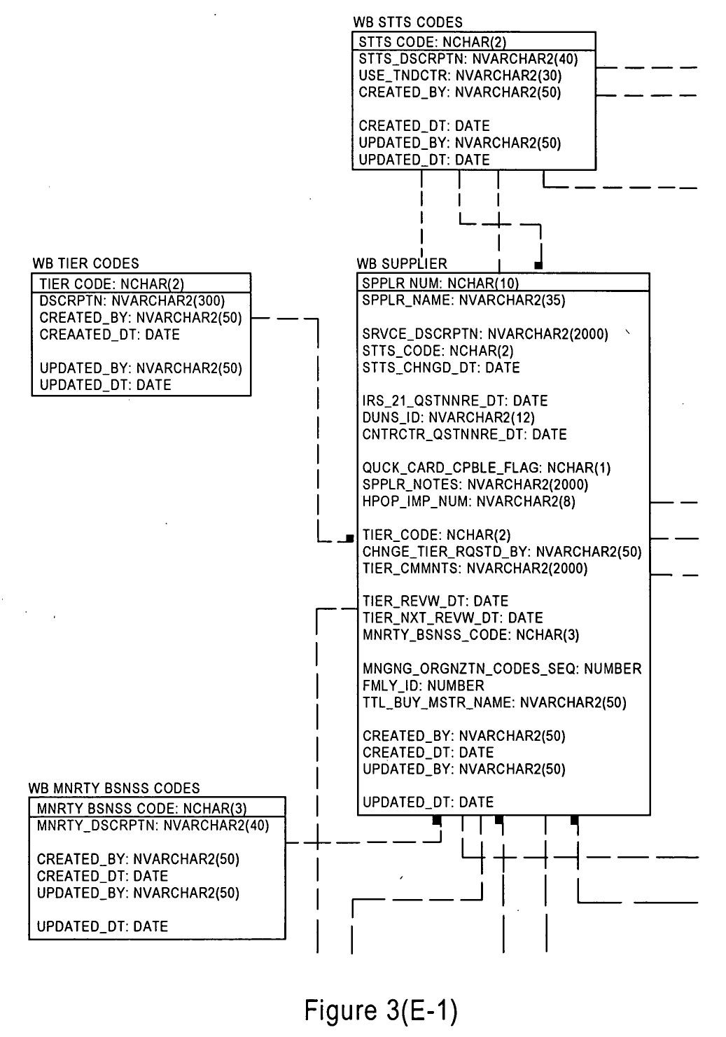

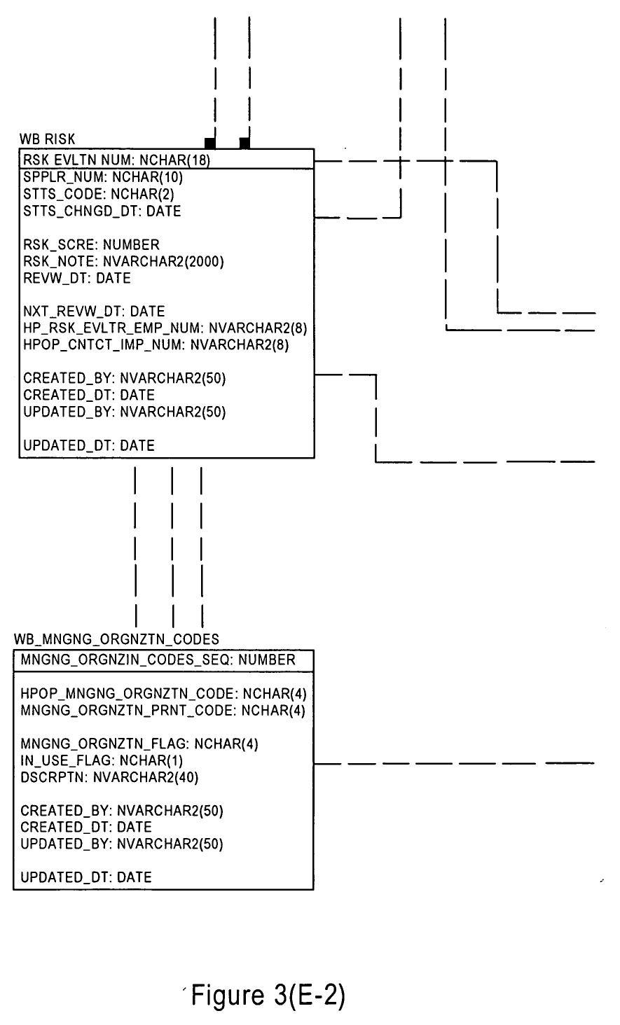

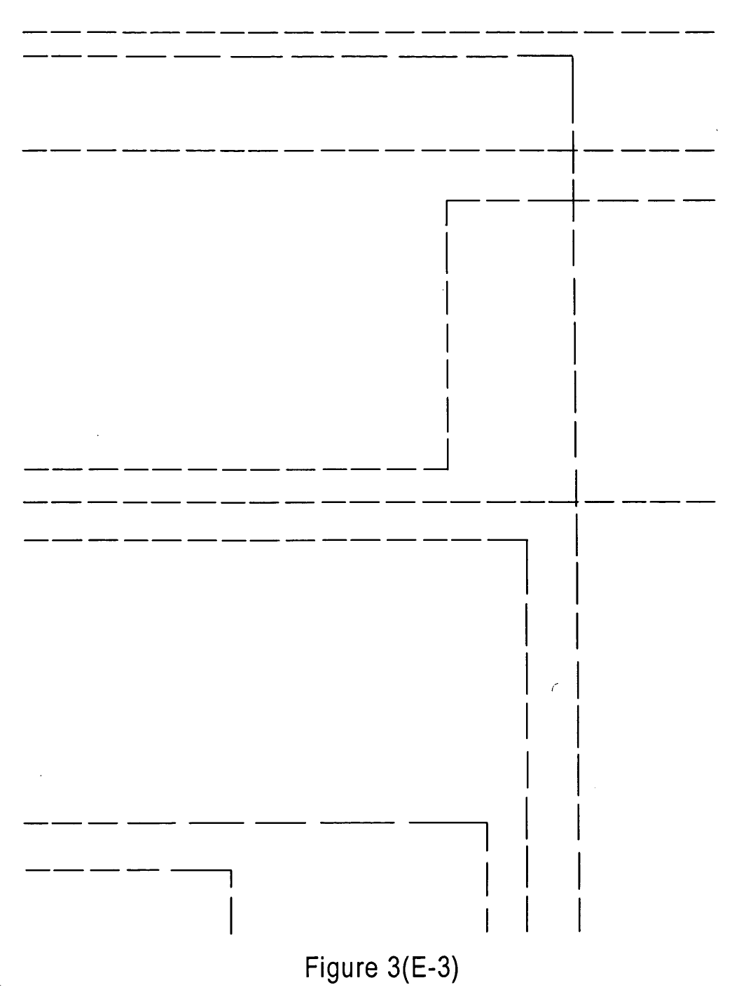

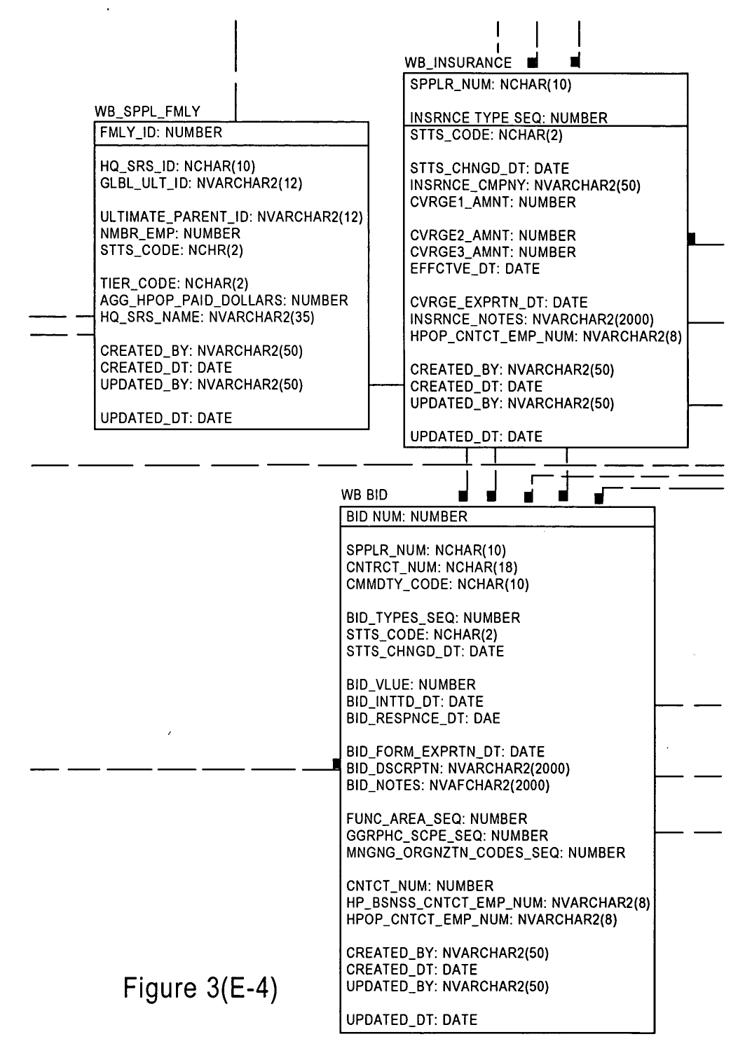

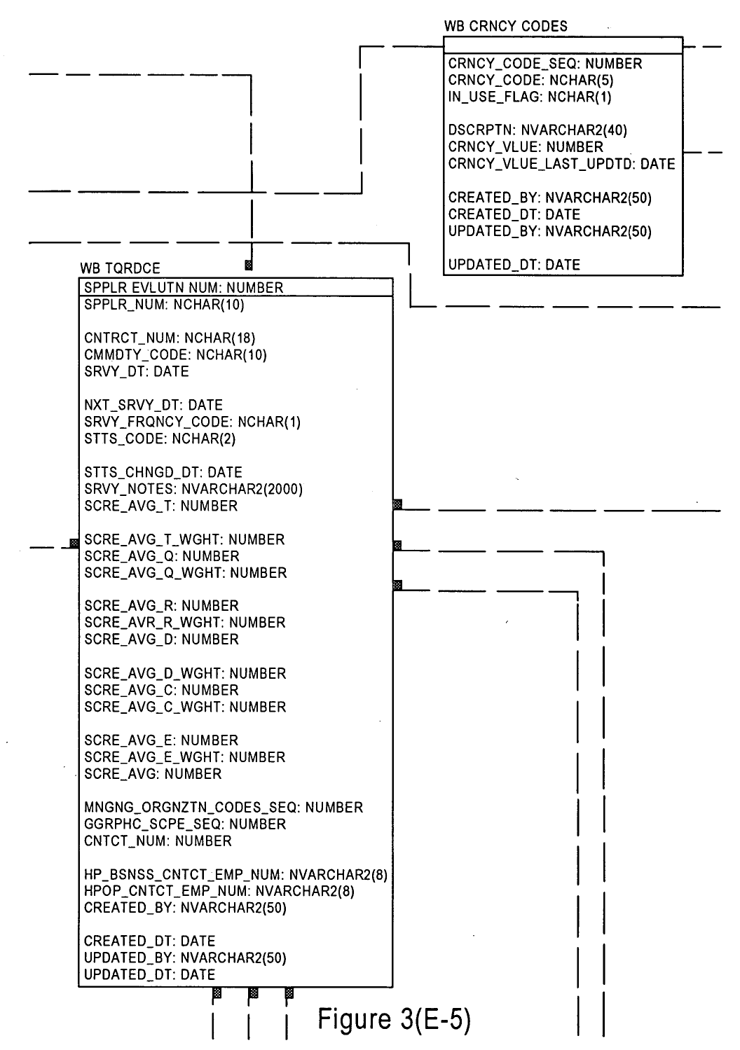

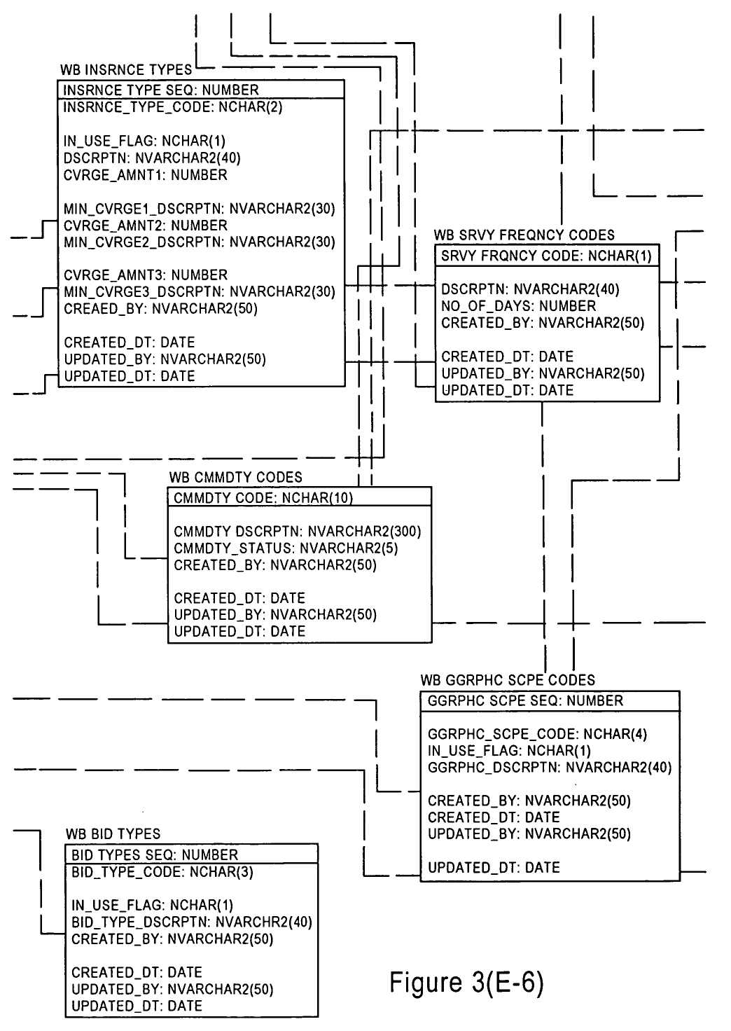

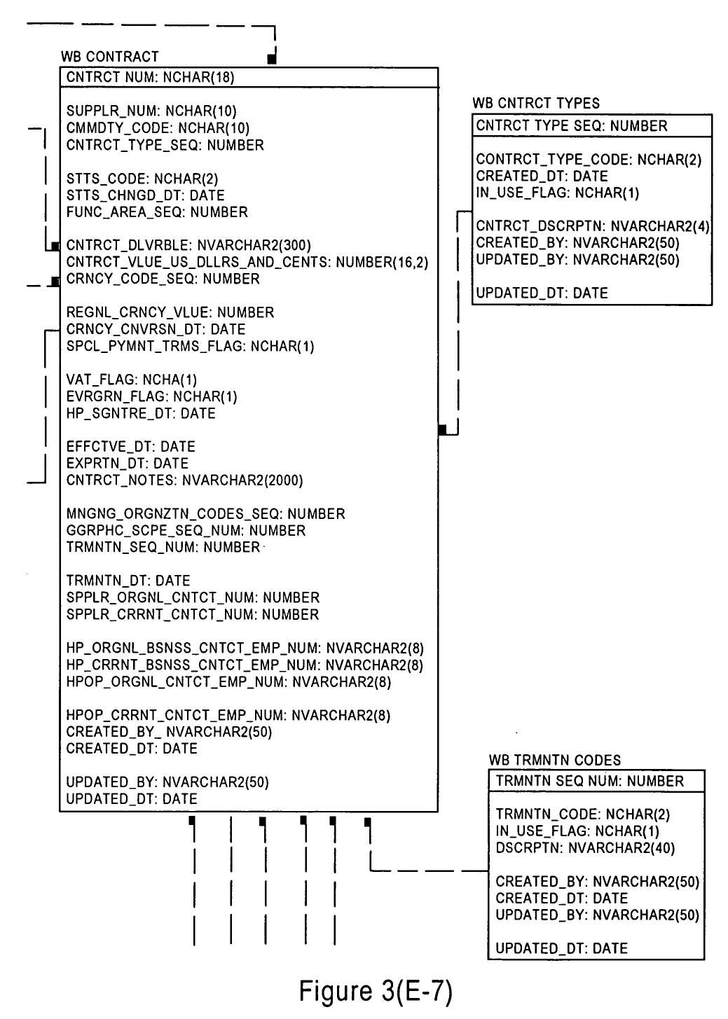

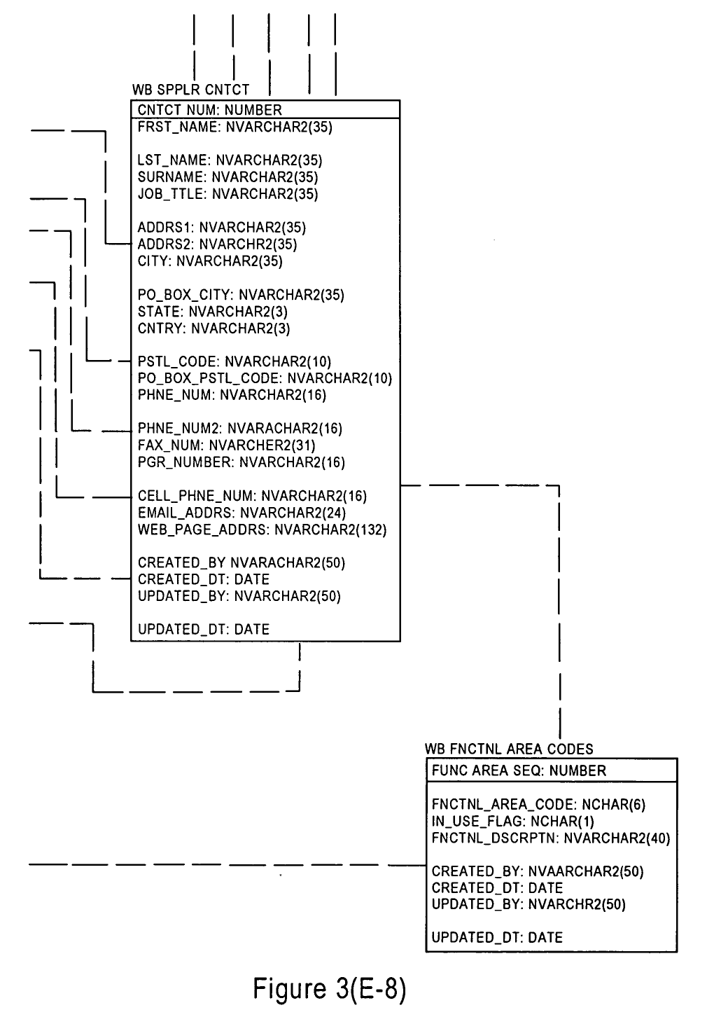

The table names (with reference to the diagram of FIG. 3 below) include:
WB₁₃SUPPLIER
WB₁₃SPPLR₁₃CNTCT
WB₁₃SUPPL₁₃CNTCT₁₃MAP

The fields of interest in the above tables include:
## In WB₁₃SUPPLIER table:
SPPLR₁₃NUM
DUNS—ID
MNRTY₁₃BSNSS₁₃CODE
SPPLR₁₃NAME
## In WB₁₃SPPLR₁₃CNTCT table:
CNTCT₁₃NUM
ADDRS1
ADDRS2
CITY
PO₁₃BOX₁₃CITY
STATE
CNTRY
PSTL₁₃CODE
PO₁₃BOX₁₃PSTL₁₃CODE
PHNE₁₃NUM p1 PHNE₁₃NUM 2
FAX₁₃NUM
WEB₁₃PAGE₁₃ADDRS
CREATED₁₃BY
CREATED₁₃DT
## In WB₁₃SUPPL₁₃CNTCT₁₃MAP table:
SPPLR₁₃NUM
CNTCT₁₃NUM
PRIMARY₁₃FLAG

The script reads one record at a time from the input file and checks the validity of the record. If there is any problem with any input record, the problem is reported and the script aborts. The whole loading process is treated as a transaction. For an input data file, all the supplier records are loaded to Workbench 100. If a supplier record from input data files fails to load because of an error, the script will rollback and the error is logged into the log file. Also, in a particular embodiment, an email is sent out, stating the failure.

If the input record is valid, then the record contains either a new record for a Supplier or updated information about an existing Supplier. The following steps are used to ensure proper insertion of a new record or update of an existing record:
1. Enable the database transaction mode.
2. Read the input data file record by record. Each record contains information for updating three tables in Workbench 100, as mentioned above.
3. Check if the given Supplier Number is in the WB₁₃SUPPLIER table.
4. If the Supplier Number is present, then update the record for the Supplier in the table. If the Supplier Number is not there, then insert a new record for the Supplier in the table.
5. Then, check if there is a Contact Number for the Supplier having a “Primary Flag” set to “Y” in table WB₁₃SUPPL₁₃CNTCT₁₃ MAP.
6. If a “Y” is not found in step 5, then insert a new record to the table for the Supplier. The Contact Number for the Supplier is generated sequentially.
7. After inserting the new record in the table, find out the associated Contact Number for the Supplier from the table.
8. Determine whether there is a record for the Contact Number in WB₁₃SPPLR₁₃CNTCT table.
9. If there is not a record, then insert the data in the table for the Contact Number. However, if there is already a record for the Contact Number (because of a database inconsistency), update the record for the Contact Number.
10. If there is a Contact Number available for the Supplier Number in WB₁₃SUPPL₁₃CNTCT₁₃MAP table, then take the Contact Number for the Supplier and insert or update the record corresponding to the Contact Number in the WB₁₃SPPLR₁₃CNTCT table.

Finally, upon successful completion in a particular embodiment, the script sends an email stating the status and attaches the log file. The log file is very informative and is reviewed in case of any failures. In case of failures, the script also sends an email to an administrator user.

Commodity Code Object

The commodity codes are obtained from United Nations Standard Products and Services Code (UNSPSC). Commodity code object downloads the codes on a fortnightly frequency.

The commodity code interface is necessary for obtaining commodity code updates from UNSPSC, which are available in the form of Excel data. The downloaded data must be processed for loading the commodity code and their respective descriptions in the Workbench database table: wb₁₃cmmdty₁₃codes.

The processing of the data file means the flat file is generated from the Excel file, which will only contain the commodity code and description.

Each record of the flat file is appended with the data ‘UNSPSC’ to fit in the Created By column of the table, and the system date (date the code is uploaded into Workbench 100 ) to fit in the column, Created Date, in the Workbench database table.

The commodity code, which is available in the Workbench database, consists of a 10-character code and bears a description with it. The code is segmented as follows:

| | |
|---|---|
| First 2 Characters | Segment |
| Second 2 Characters | Family |
| Third 2 Characters | Class |
| Fourth 2 Characters | Commodity |
| Fifth 2 Characters | BTI (currently NOT Used) |

Total Buy Object

Total Buy is a worldwide database of selected financial data. Total Buy stores all the data in a Total Buy Server, which in one particular embodiment includes NT 4.0 and SQL Server 7.0 software. Providing a solution for the requirements of the Workbench project is a two-step process:
1. Pull data from Total Buy; and
2. Update the pulled data in Workbench database.

The pulled data consists of the VendorMasterName, aggregate paid dollars to the Vendor, and the dollar amount paid every month to the vendor for the last 24 months. A batch program executes once a month to pull the data and update the Workbench database.

To update an Aggregate₁₃Total₁₃Buy table, a Supplier Number is obtained from Supplier₁₃meta₁₃data and Total₁₃Buy₁₃Master₁₃Name and Total₁₃HP₁₃Paid₁₃dollars from Total Buy database. To update a Monthly₁₃Total₁₃Buy table, a Supplier Number is obtained from Supplier₁₃meta₁₃data and HPI/SP₁₃Paid₁₃Dollars.

A financial server maintains the details of different currencies available and the applicable conversion rate with respect to Dollars. In Workbench 100, it is necessary to have various currency codes and conversion rates available to users. For this reason, the interface implements the data to be made available locally.

The financial server provides the data in an XLS file. The data file is programmatically downloaded, converted to a text file, and loaded to the appropriate table in Workbench 100. This process executes on the first of every month.

The Workbench application includes a scheduled process, e.g., a Cron job, for execution each month in the system to process the data file from the financial server.

## Fields affected in the wb₁₃cmcy₁₃codes table include:
CRNCY₁₃CODE
IN₁₃USE₁₃FLAG
DSCRPTN
CRNCY₁₃VLUE
CRNCY₁₃VLUE₁₃LAST₁₃UPDTD
CREATED₁₃BY
CREATED₁₃DT
   Enterprise Directory Object

Workbench 100 stores information, such as the good and service procurement personnel Contact name, procurement personnel Business Contact name, Telephone number, Physical Location, or Organization. This information is related to the particular business Employees working for Procurement Operations. The information related to the particular business Employees is stored in the Enterprise Directory Server. Any changes occurring related to the employee are updated directly into the Enterprise Directory Server. Such changes include changes in the Telephone, organization restructure, change in the manager name, employee termination, and so forth.

The Enterprise Directory database is replicated into the system where the good and service procurement Workbench application executes. The Enterprise Directory provides the download of the complete database in a file. Workbench 100 has a process scheduled for execution every 24 hours to perform the download. In this manner, the replicated Enterprise Directory synchronizes with the Enterprise Directory with a maximum time lag of 24 hours. In addition, the information about the terminated employees is stored in the replicated Enterprise Directory although they might have been physically removed from the Enterprise Directory after some duration of time.

Document Library Object

Document library object 118 is a storage site for workbench-related documents. Document library object 118 is implemented in one particular embodiment by installing FILENET—a registered product from FileNet Corporation. FILENET is based on MICROSOFT technologies and can be installed on WINDOWS NT with an MS-SQL Server database.

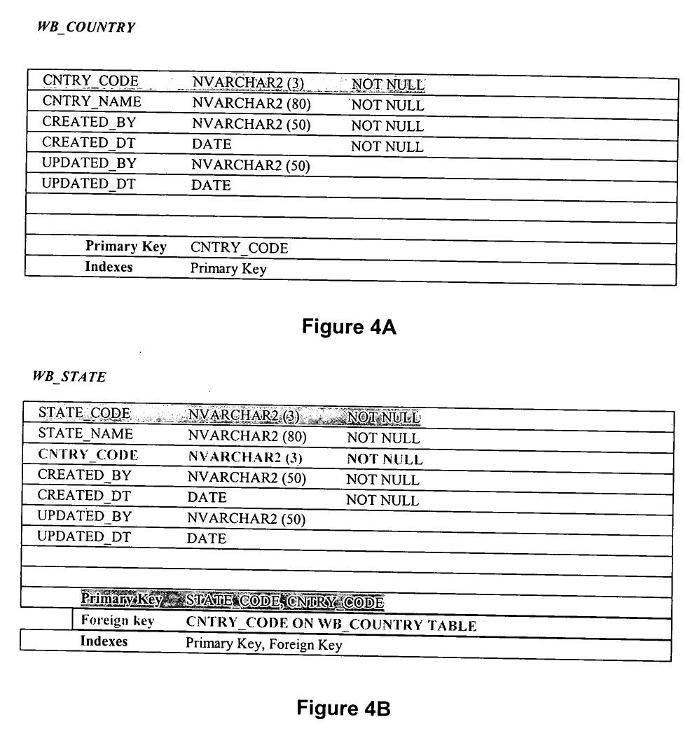

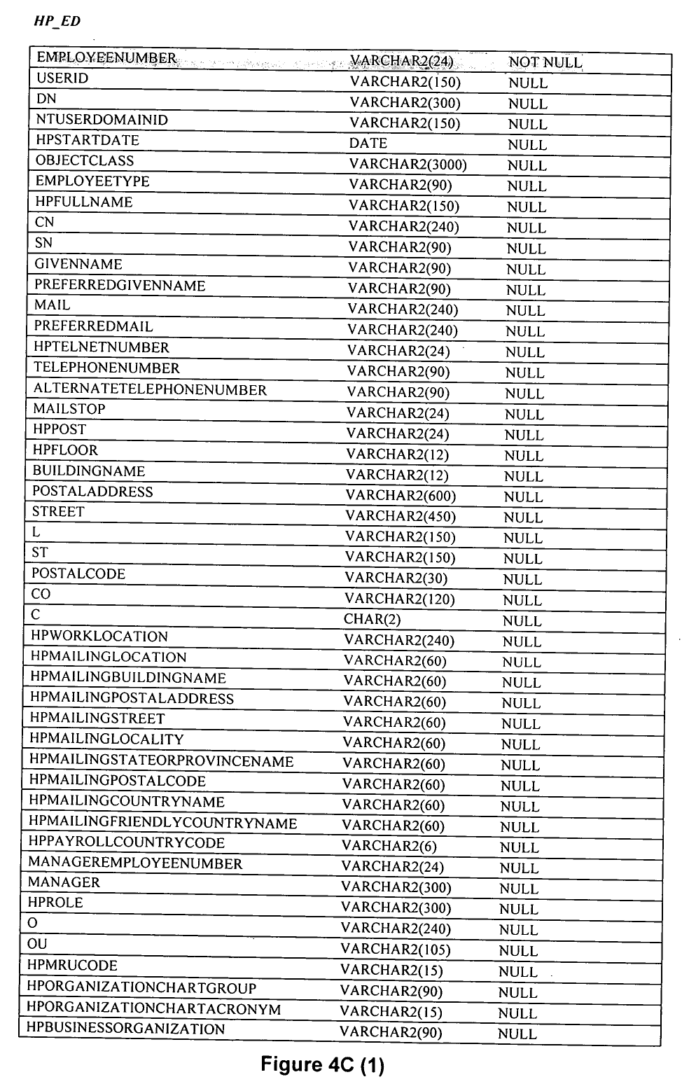

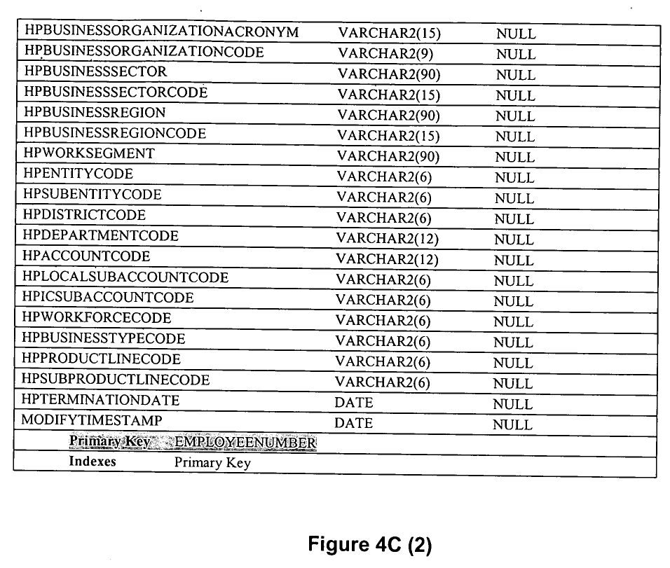

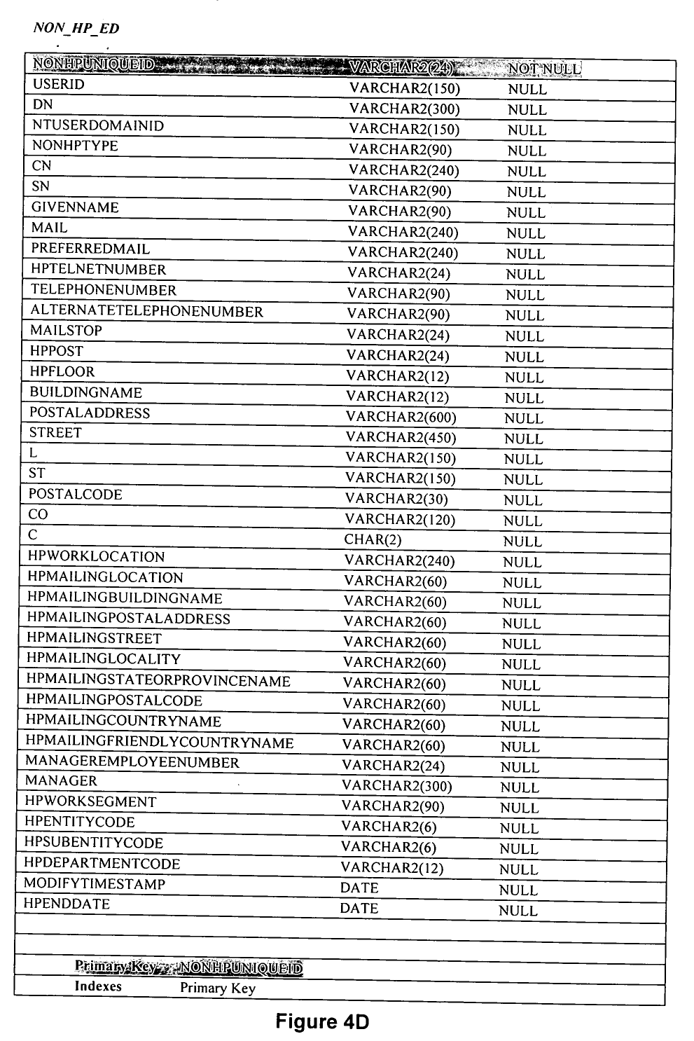

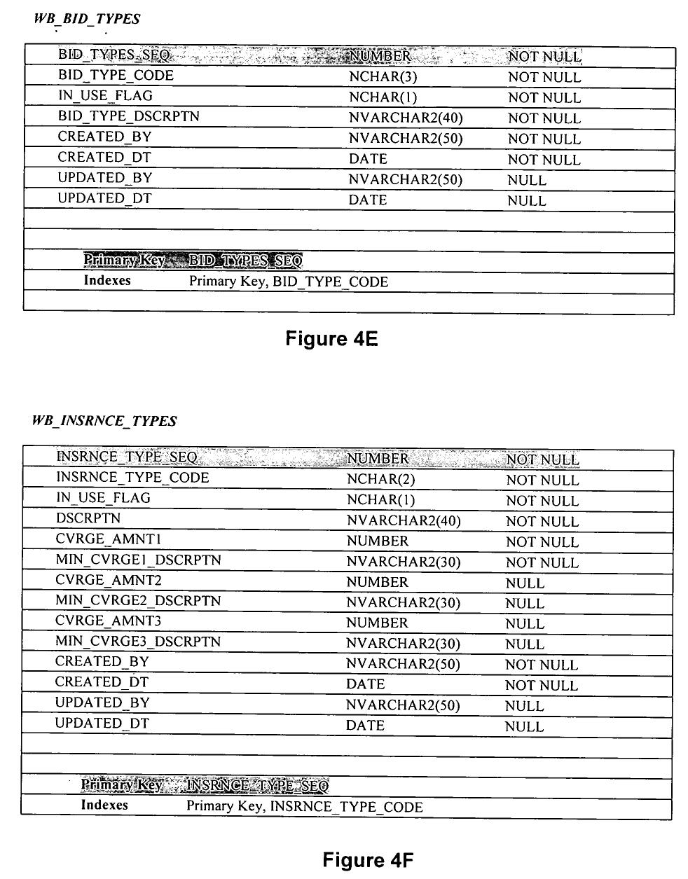

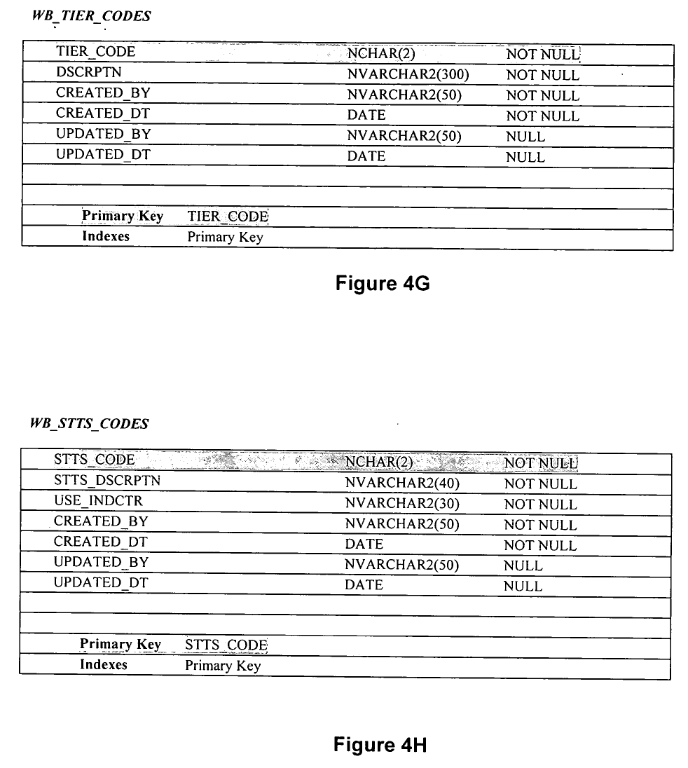

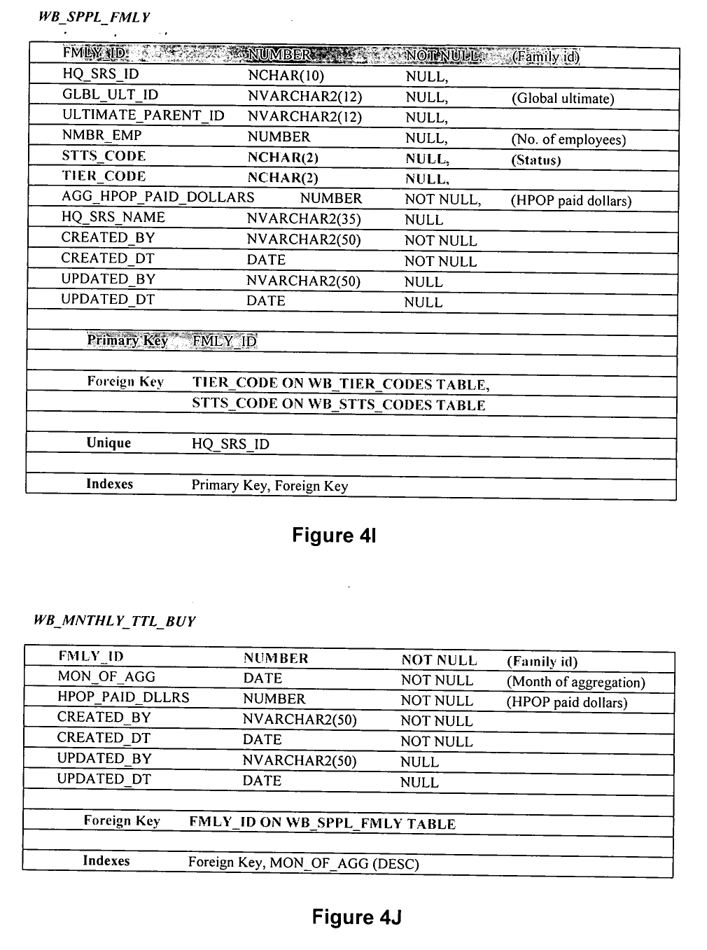

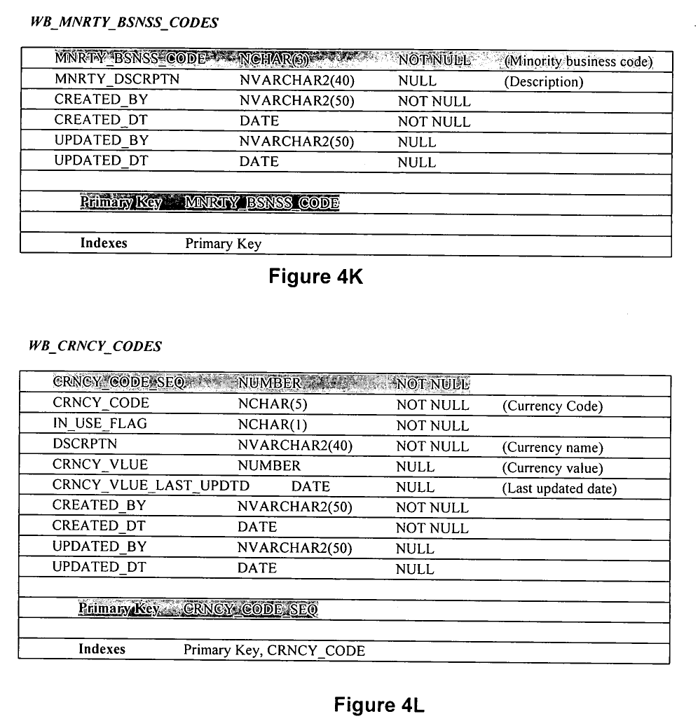

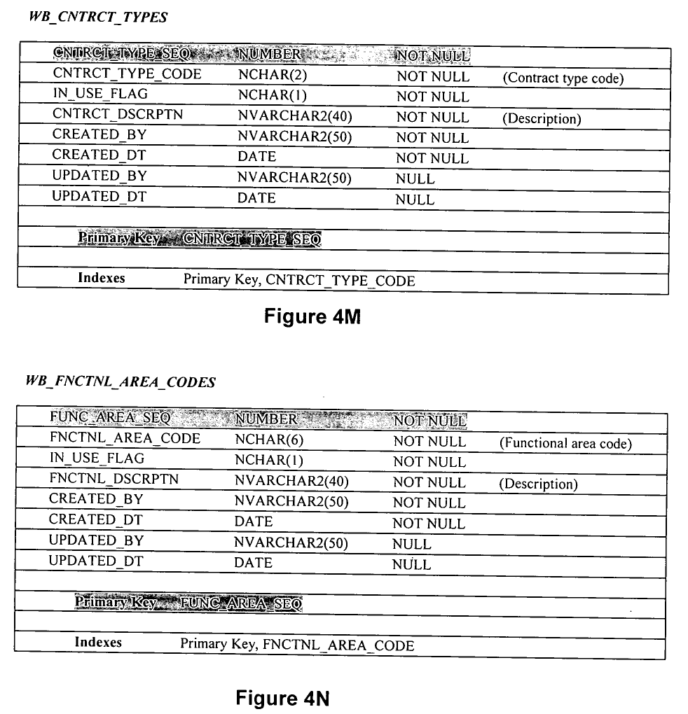

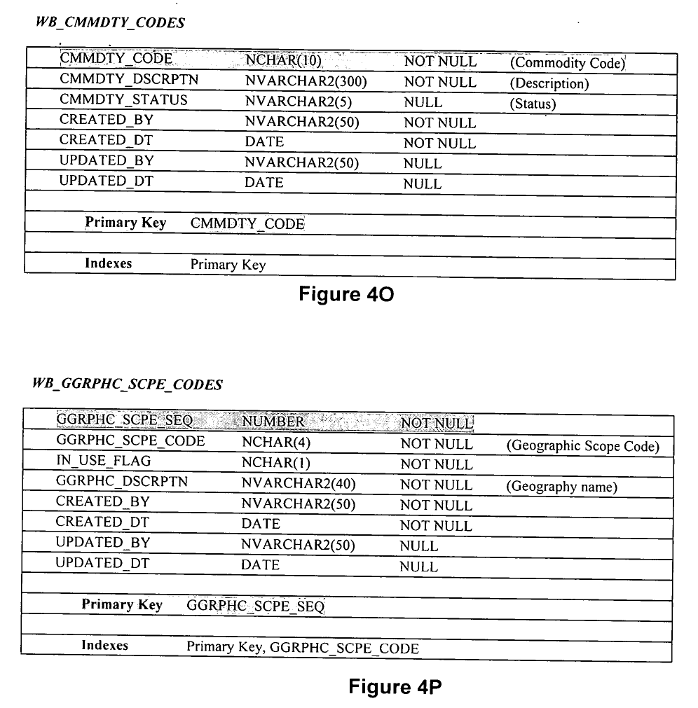

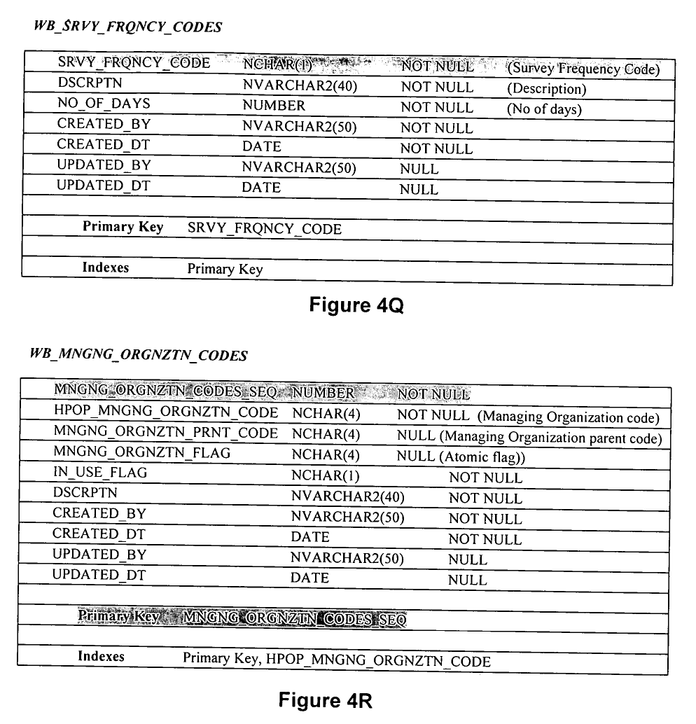

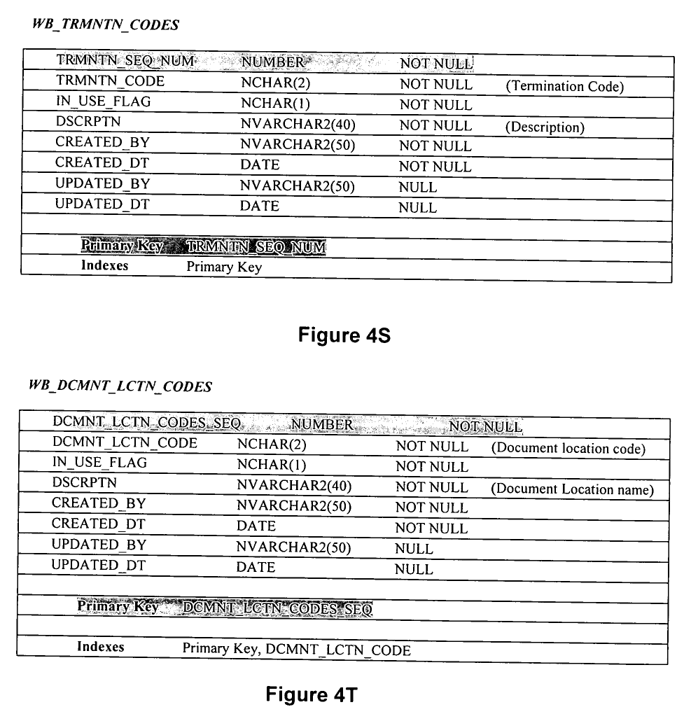

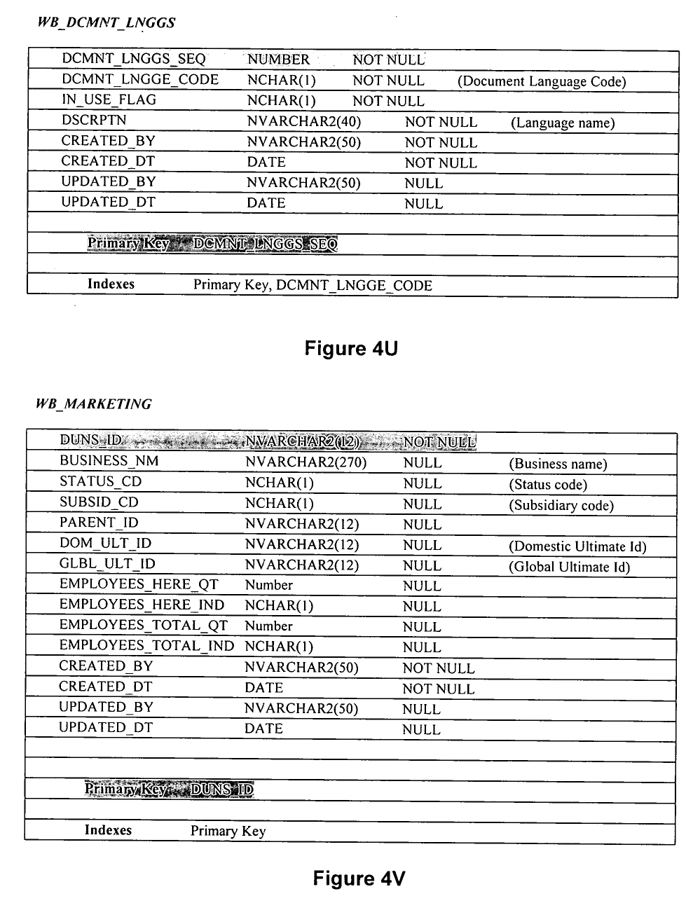

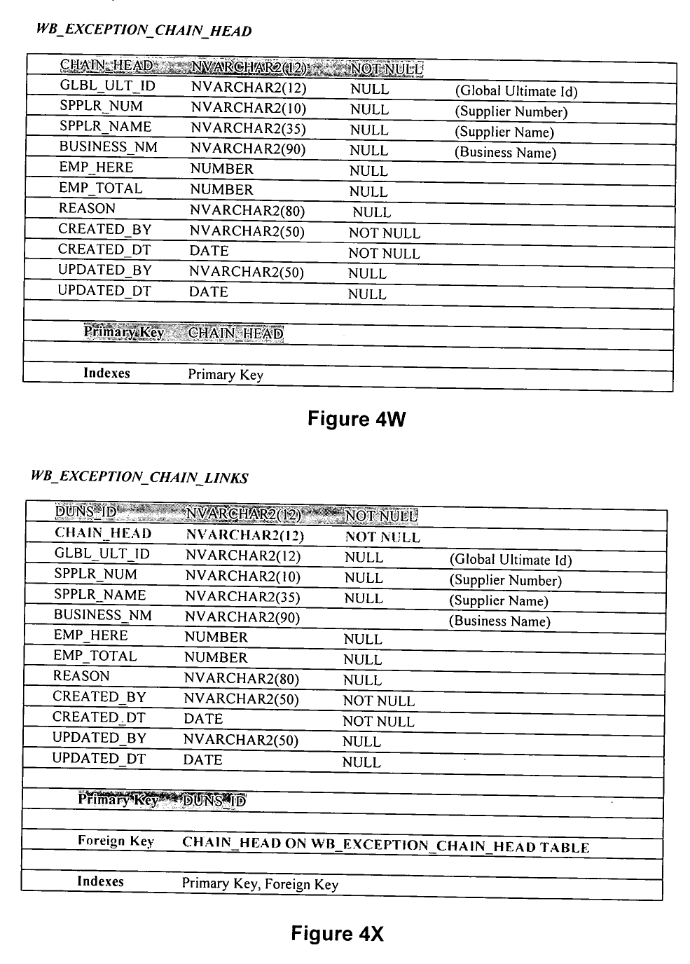

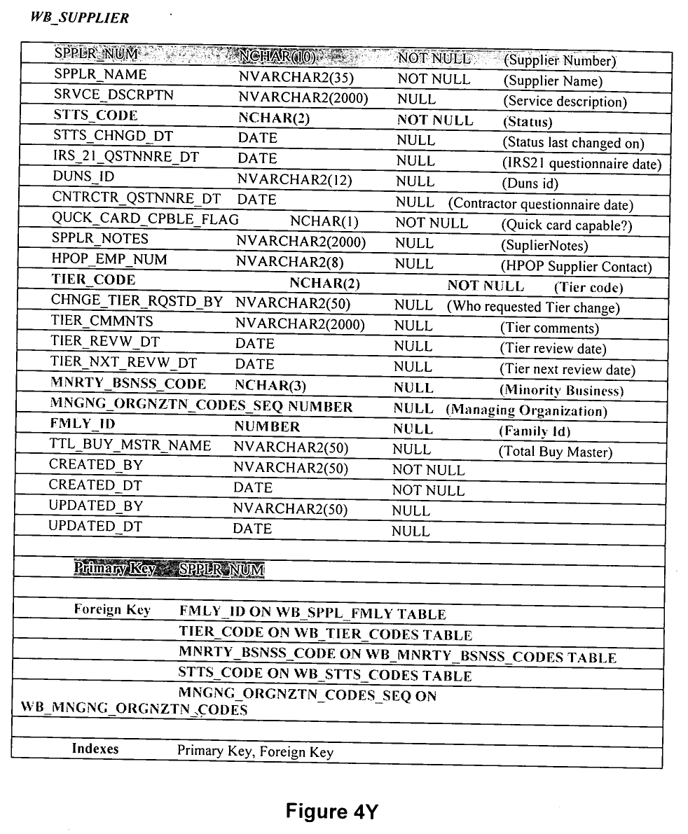

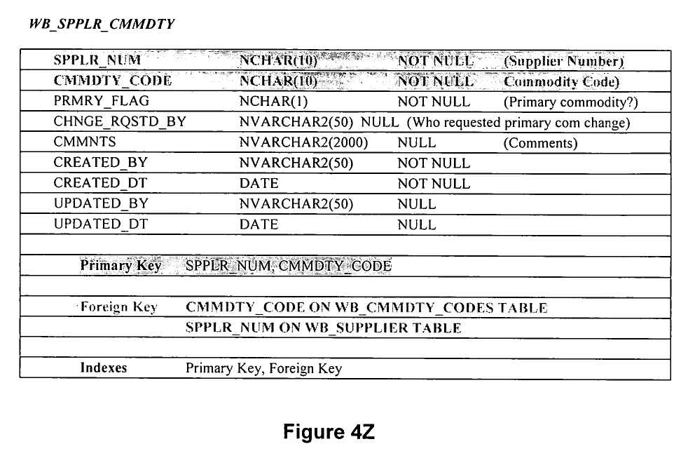

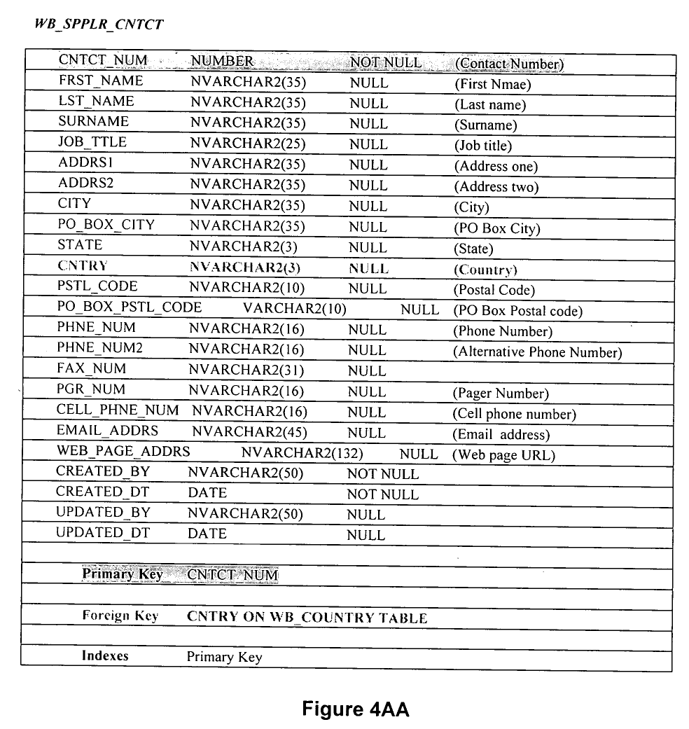

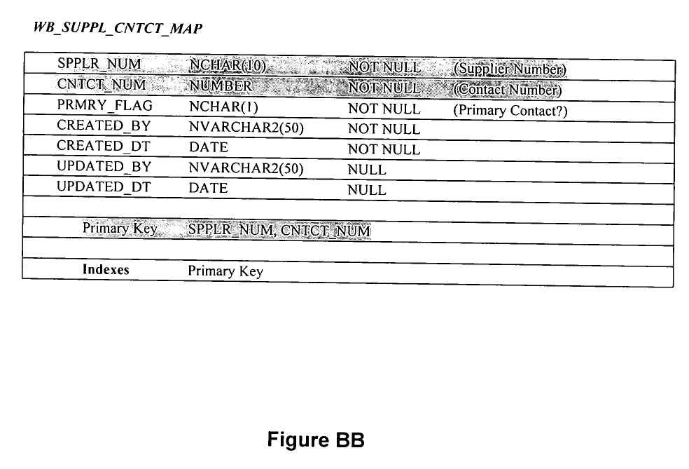

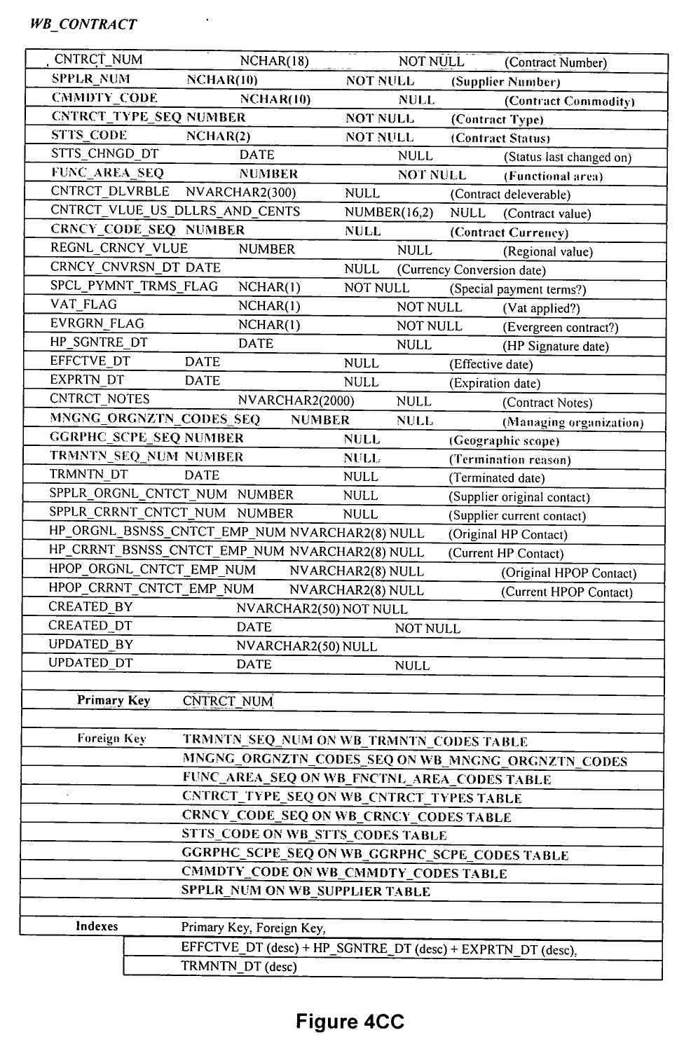

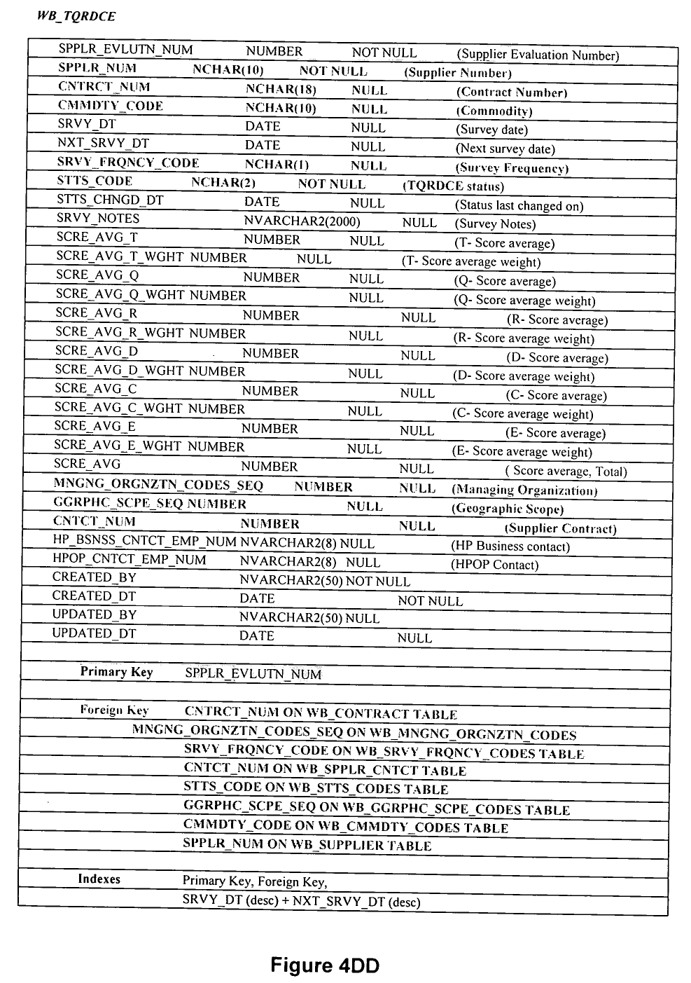

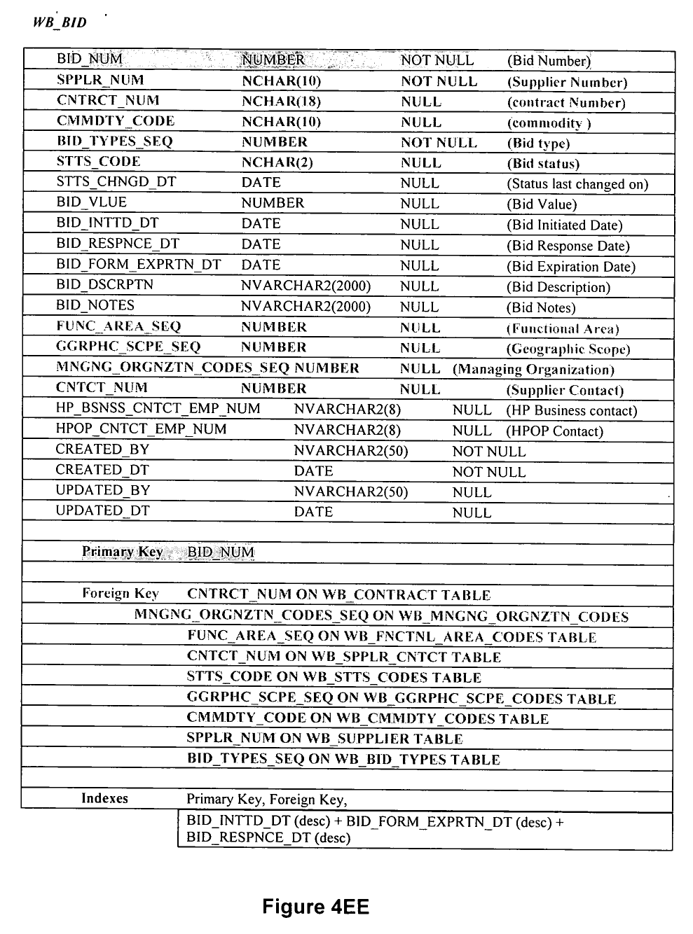

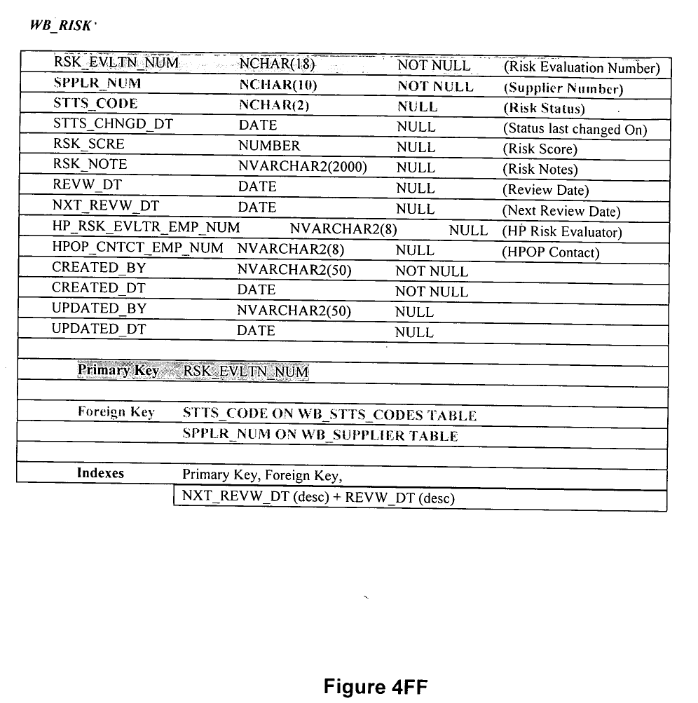

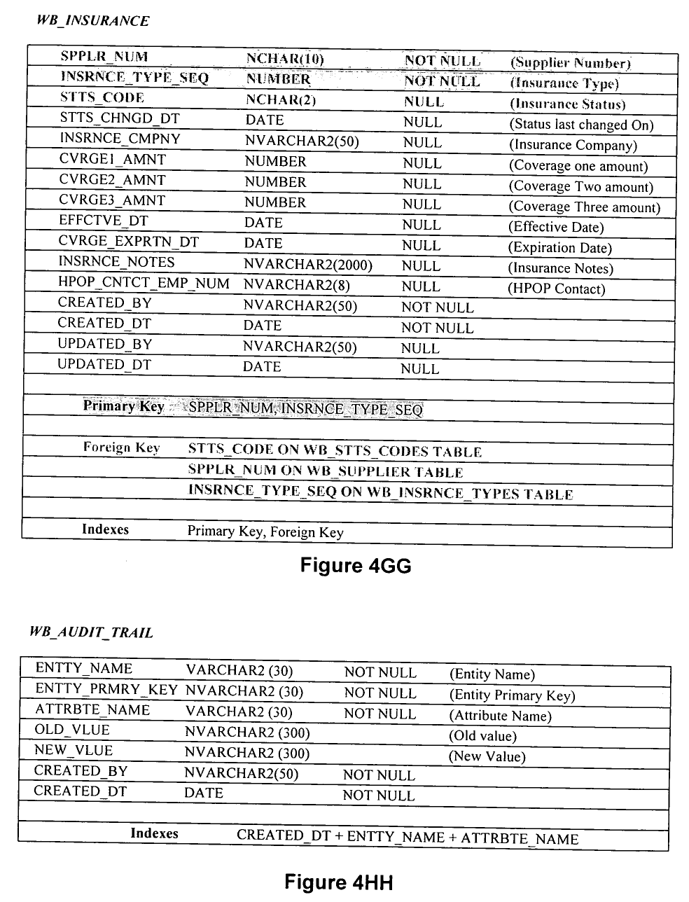

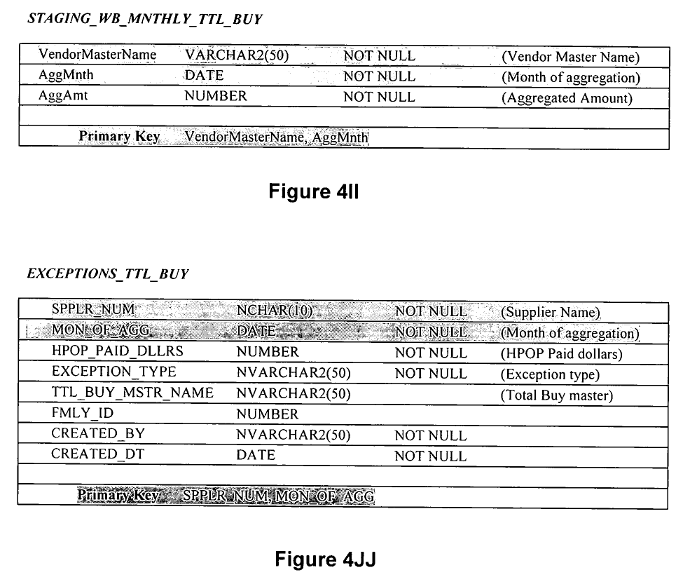

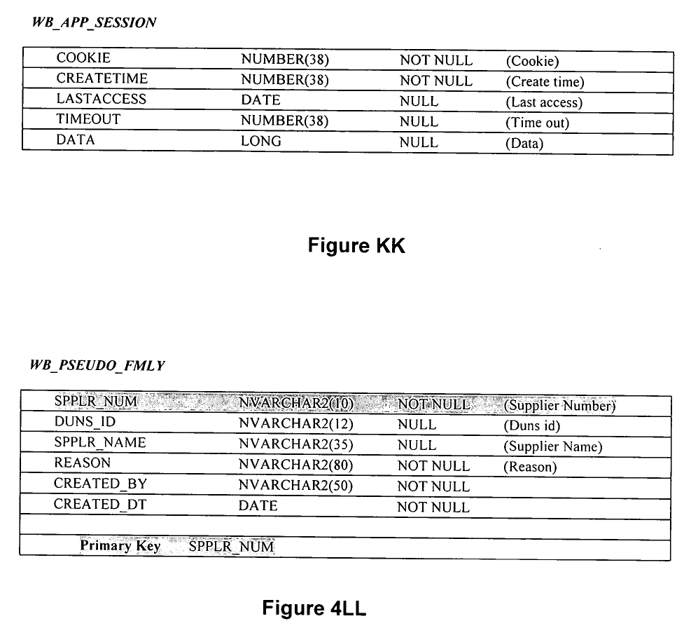

FIG. 3 is an entity relationship diagram of C/S database 102. The entity relationship diagram depicts the relationship between entities stored in the C/S database 102 and additional information stored in the C/S database received from the external objects. FIGS. 4A through 4LL depict tables included in C/S database 102.

Good and Service Procurement Web Portal Object

Returning now to FIG. 1, good and service procurement web portal object 104 enables access to workbench 100 users by providing a front end graphical user interface (GUI) as described in detail below. In one particular embodiment, good and service procurement web portal object 104 is a web site located on a company intranet network and accessible to authorized users. In another embodiment, good and service procurement web portal object 104 is accessible over the Internet by authorized users.

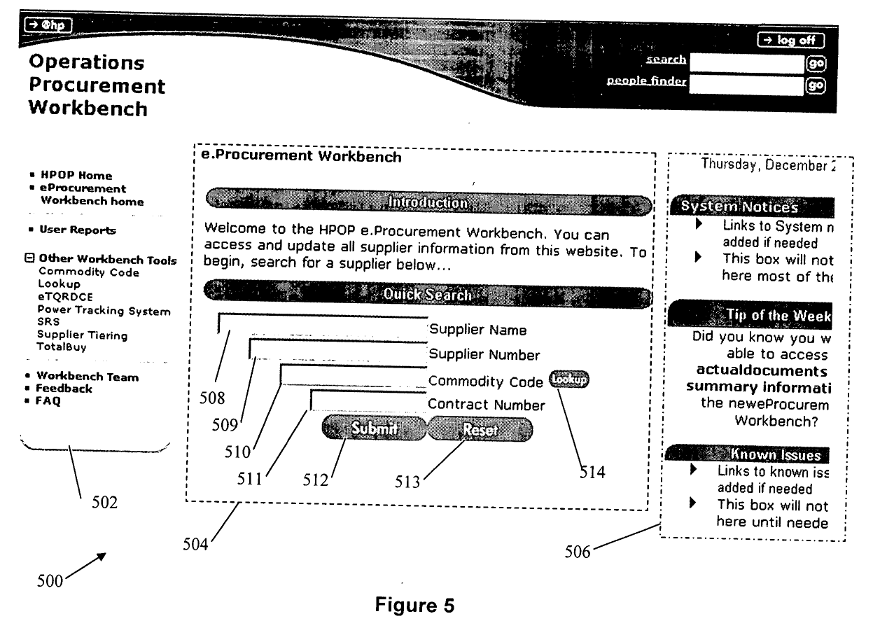

FIG. 5 is an exemplary GUI 500 usable in conjunction with an embodiment of the procurement workbench 100, and more specifically the good and service procurement web portal object 104, according to the present invention. In one particular embodiment, GUI 500 is a markup language-based document for viewing using a browser, e.g., MICROSOFT INTERNET EXPLORER or NETSCAPE NAVIGATOR; however, it will be understood by those of skill in the art that the browser could be replaced by an application-specific client program, i.e., software executable executing on client computer system and accessing a server or other computer system.

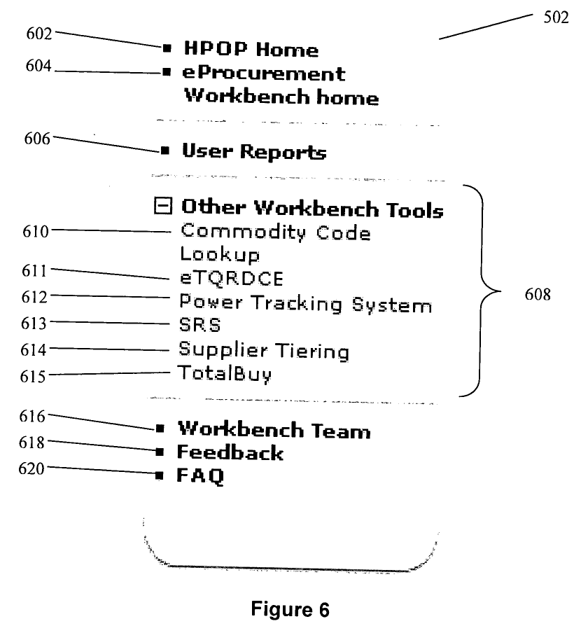

GUI 500 includes a navigation bar 502, a central input section 504 (dashed line), and an additional information section 506 (dash dot line). An enlarged version of navigation bar 502 is depicted in FIG. 6 and described in detail below. Central input section 504 includes: (1) an upper text region providing introductory and/or explanatory text pertaining to the procurement workbench, and more specifically GUI 500 and (2) a lower search input region having several search input fields 508-511, and activatable buttons 512-514. Additional information section 506 includes regions providing further information to the user, e.g., current date, system-specific notices, tips, and known issues. Many of the items depicted on GUI 500 are activatable links, e.g., text items may be hyperlinks activatable by a user clicking on the item.

Turning first to central input section 504, the several search input fields 508-511 include a supplier name search field 508, a supplier number search field 509, a commodity code search field 510, and a contract number search field 511. Supplier name search field 508 enables a user to search for information related to a particular supplier by entering all or part of a supplier name in search field 508 and activating a submit link 512, e.g., an activatable hyperlink button. In order to clear one or more entries in fields 508-511, the user activates a reset link 513 thereby causing any information in the fields to be cleared enabling the user to enter search criteria. Responsive to a supplier name search, supplier number search, commodity code search, and/or a contract number search entry, and activation of submit link 512, workbench 100 searches entries in C/S database 102 for an entry having a matching supplier name, supplier number, commodity code, and/or contract number.

If a matching entry is found, workbench 100 causes the generation and display of search result screen 5200 of FIG. 52 thereby enabling a user to select a particular supplier from the results of performing a search. As depicted in FIG. 52, a list 5202 of the matching entries is displayed to the user enabling the user to select one of the entries in the list or return to GUI 500 and modify or initiate additional searches using a search section 5204. If no matching entry is found, search result screen 5200 includes no entries in list 5202 and the user is able to initiate a revised search using search section 5204.

Profile Tab

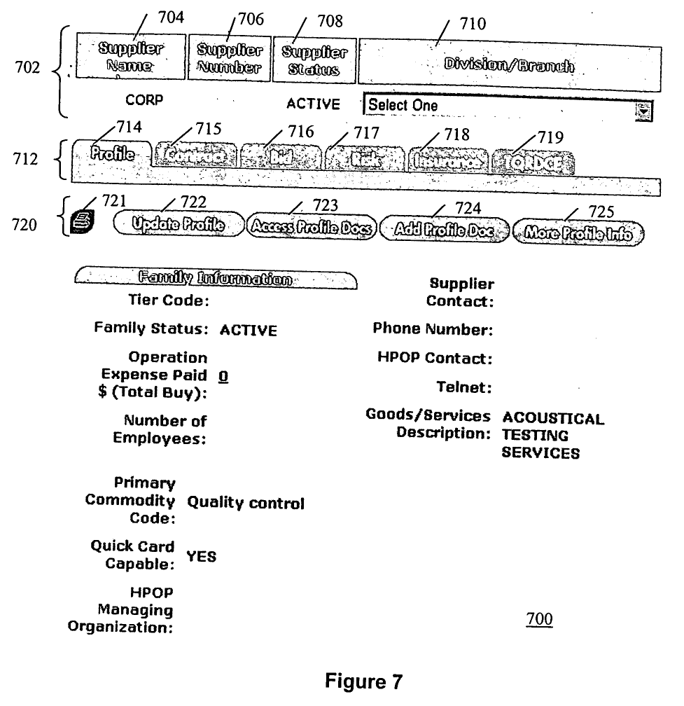

If a matching entry in screen 5200 of FIG. 52 is activated by the user, profile screen 700 of FIG. 7 is displayed to the user as described below.

Profile screen 700 displays all the basic supplier information stored in C/S database 102. A header section 702 depicts a supplier name 704, a supplier number 706, a supplier status 708, and a drop-down division/branch field 710. A user manipulates drop-down division/branch field 710 to select a particular division or branch of a supplier for review/update. A tab section 712 enables access to additional supplier-related information: profile tab 714, contract tab 715, bid tab 716, risk tab 717, insurance tab 718, and TQRDCE tab 719. Each tab 714-719 is an activatable link enabling access to another screen providing specific supplier-related information.

A button section 720 includes a series of buttons 721-725 enabling access to additional supplier-related functionality: print format button 721, update profile button 722, access profile docs button 723, add profile docs button 724, more profile info button 725. The remainder of profile screen 700 provides the basic supplier information in several fields as depicted.

Activation of print format button 721 causes the generation and display of a formatted version of profile screen 700 (for example a capsule view) in a printer-friendly format. A capsule view of the information on a screen eliminates many graphic elements and includes only pertinent data.

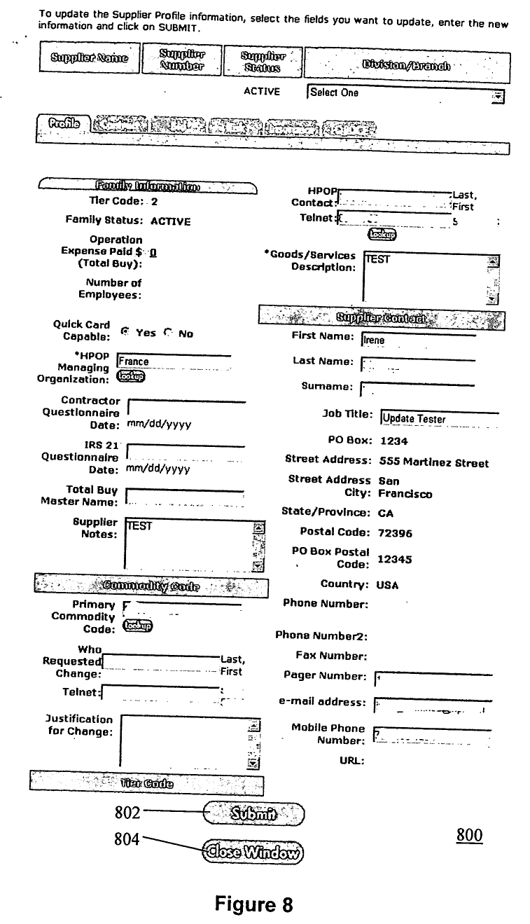

Activation of update profile button 722 causes the generation and display of update profile screen 800 as depicted in FIG. 8 enabling the user to modify supplier profile related information. After modifying information, the user activates a submit link 802 to cause entry of the information into C/S database 102. Alternatively, the user may activate close window link 804 to cause screen 800 to close and return the user to profile screen 700.

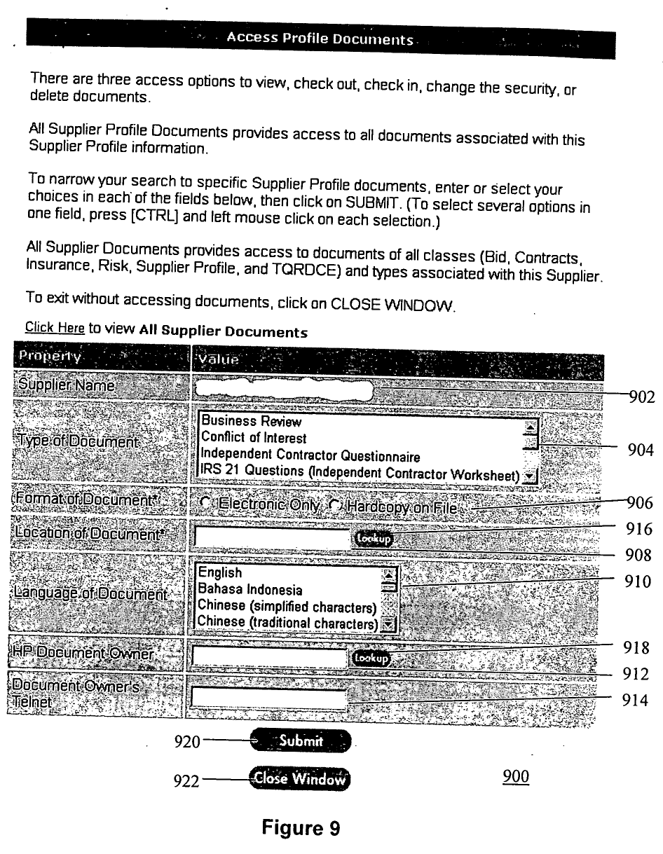

Activation of access profile docs button 723 causes the generation and display of access profile documents screen 900 as depicted in FIG. 9 thereby enabling the user to access documents related to the supplier from document library 118. Access profile documents screen 900 includes a supplier name field 902 for displaying the supplier name, a document type list 904 for selecting a particular document type for which to search, a document format button 906 for specifying a particular document format for which to search, a document location field 908 for specifying a particular location for which to search, a document language list 910 for specifying a particular document language for which to search, a document owner field 912 for specifying a particular document owner for which to search, and an owner telephone field 914 for specifying a particular Telephone of a document owner for which to search. Additionally, document location field 908 and document owner field 912 include corresponding lookup links 916, 918 enabling entry of the information by accessing a lookup screen (not shown).

After the user fills in desired search parameters, the user activates submit link 920 and workbench 100 executes a search of document library 118 and returns matching documents and/or document references in a list (not shown) to the user for viewing. User activation of close window link 922 causes screen 900 to close and returns the user to profile screen 700.

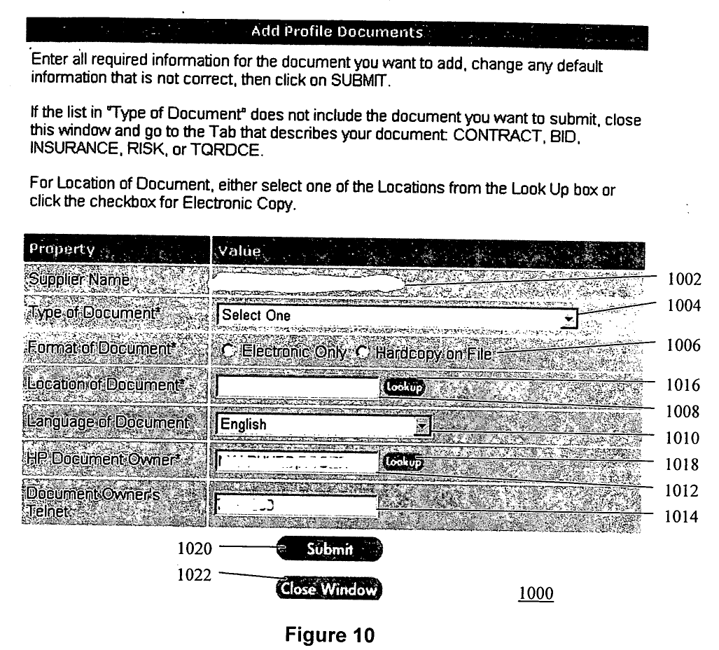

Activation of add profile docs button 724 causes the generation and display of add profile documents screen 1000 as depicted in FIG. 10 thereby enabling the user to add profile document information to library 118. Add profile documents screen 1000 is an input screen corresponding to access profile documents screen 900 and fields and links 1002-1018 operate similarly to fields and links 902-918. After the user fills in the profile document parameters, the user activates submit link 1020 and workbench 100 inserts the profile document information into document library 118 and returns the user to profile screen 700. User activation of close window link 1022 causes screen 1000 to close and returns the user to profile screen 700.

Activation of more profile info button 725 causes the generation and display of more profile information screen 1100 as depicted in FIG. 11 thereby enabling the user to view additional profile information related to a supplier. A print format button 1102 causes the generation and display of a formatted version of profile screen 1100 in a printer friendly format as described above with respect to screen 700. An access profile docs button 1104 operates similar to access profile docs button 723 on screen 700; however, access profile documents screen 900 is automatically filled in with appropriate supplier related information from the supplier displayed on more profile information screen 1100. User activation of a close window link 1106 causes screen 1100 to close and returns the user to profile screen 700.

Contract Tab

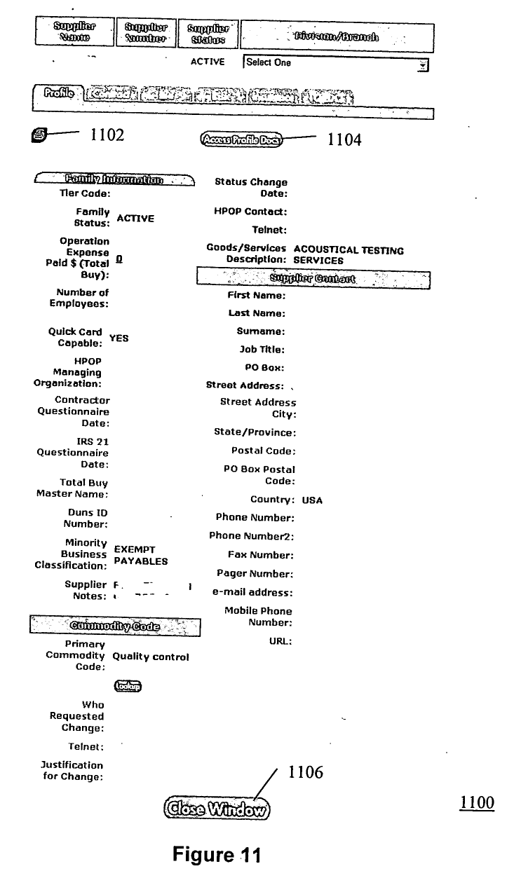

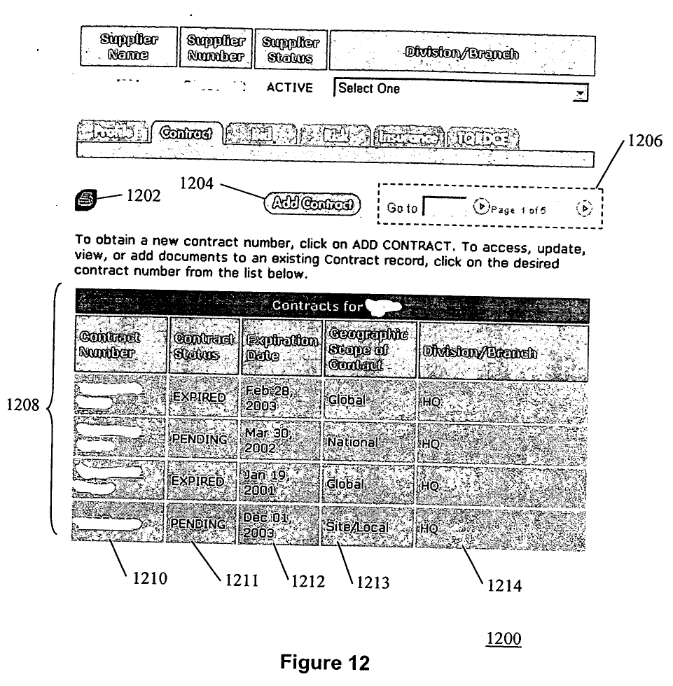

Returning now to FIG. 7, a user activating contract tab 715 causes workbench 100 to display a contract list screen 1200 as depicted in FIG. 12 thereby enabling the user to view a list of contracts related to the particular supplier. A print format button 1202 causes the generation and display of a formatted version of contract list screen 1200 in a printer friendly format as described above with respect to screen 700. The user may activate an add contract link 1204 to obtain a new contract number for the specific supplier from workbench 100. Add contract link 1204 functionality is described in detail below. Additional pages of contract lists may be navigated to through the use of navigation controls 1206 (dashed line) as is known in the art.

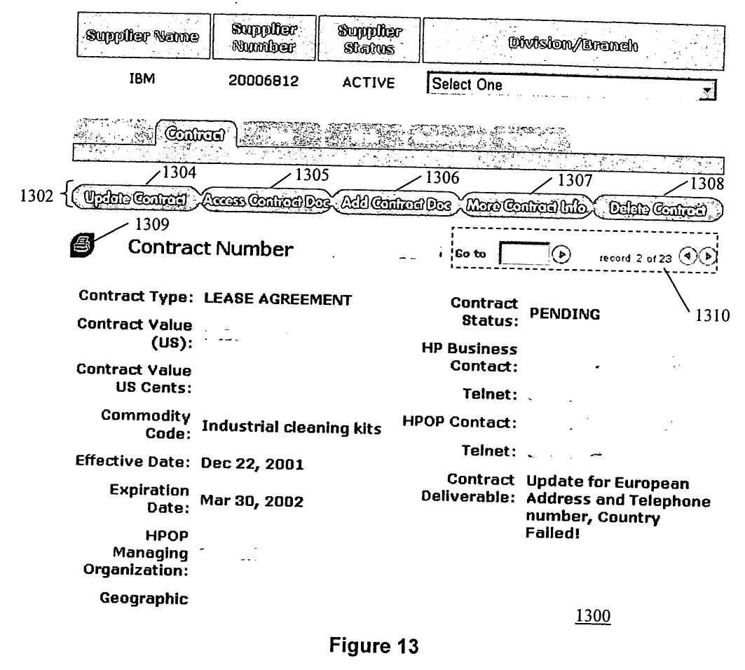

A contracts list section 1208 includes a listing of supplier-related contracts in table format where the columns include: a contract number column 1210, a contract status column 1211, an expiration date column 1212, a geographic scope of contact column 1213, and a division/branch column 1214. Each entry in the contract number column 1210 includes an activatable link for causing display of summary level information of the particular contract as described below in connection with a contract summary screen 1300 of FIG. 13.

Contract summary screen 1300 includes summary information related to a particular supplier contract. A button section 1302 includes a series of buttons 1304-1308 enabling access to additional supplier contract related functionality: an update contract button 1304, an access contract documents button 1305, an add contract document button 1306, a more contract info button 1307, and a delete contract button 1308. A print format button 1309 causes the generation and display of a formatted version of contract summary screen 1300 in a printer friendly format as described above with respect to screen 700. Additional pages of contract summary information may be navigated to through the use of navigation controls 1310 (dashed line) as is known in the art.

The remainder of summary screen 1300 includes summary contract information including contract type, contract value, commodity code of the contract, effective date, expiration date, good and service procurement managing organization, geographic location of the contract, contract status, business contact and telephone, good and service procurement contact and telephone, and any contract deliverable.

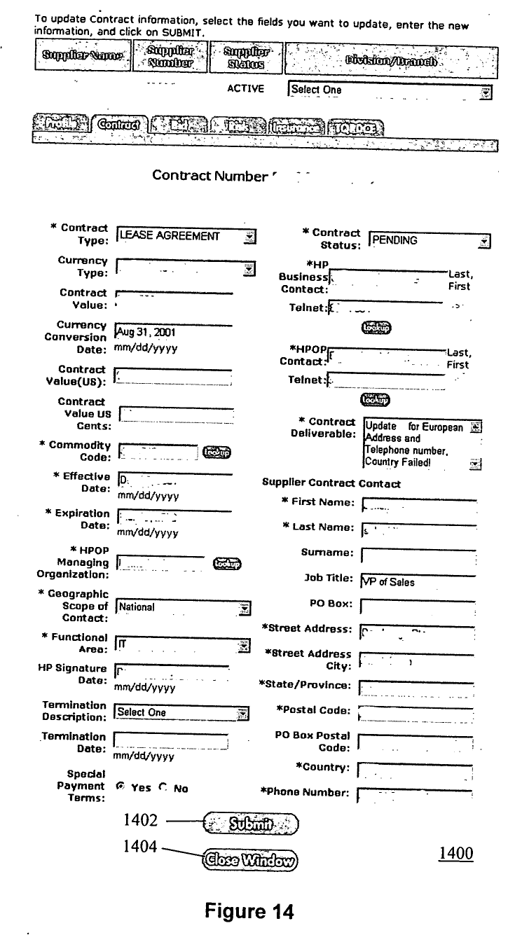

Activation of update contract button 1304 in contract summary screen 1300 causes the generation and display of update contract screen 1400 as depicted in FIG. 14 enabling the user to modify supplier contract related information. After modifying information, the user activates a submit link 1402 to cause entry of the information into C/S database 102. Alternatively, the user may activate close window link 1404 to cause screen 1400 to close and return the user to contract summary screen 1300.

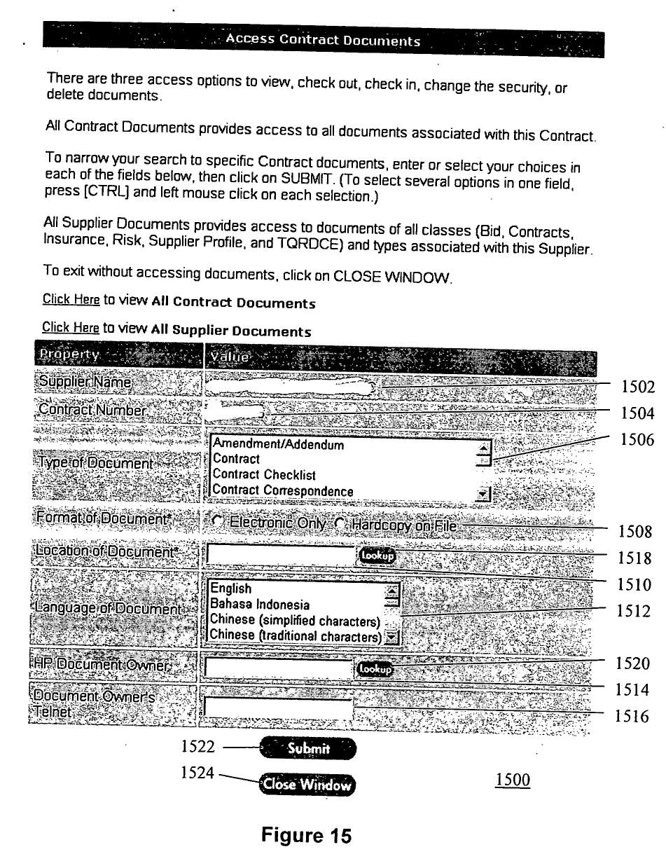

Activation of access contract docs button 1305 causes the generation and display of access contract documents screen 1500 as depicted in FIG. 15 thereby enabling the user to access contract documents related to the supplier from document library 118 similar to access profile documents screen 900 described in detail above. Access contract documents screen 1500 includes a supplier name field 1502 for displaying the supplier name, a contract number field 1504 for displaying the contract number, a document type list 1506 for selecting a particular document type for which to search, a document format button 1508 for specifying a particular document format for which to search, a document location field 1510 for specifying a particular location for which to search, a document language list 1512 for specifying a particular document language for which to search, a document owner field 1514 for specifying a particular document owner for which to search, and an owner telephone field 1516 for specifying a particular telephone of a document owner for which to search. Additionally, document location field 1510 and document owner field 1514 include corresponding lookup links 1518, 1520 enabling entry of the information by accessing a lookup screen (not shown).

After the user fills in desired search parameters, the user activates submit link 1522 and workbench 100 executes a search of document library 118 and returns matching documents and/or document references in a list (not shown) to the user for viewing. User activation of close window link 1524 causes screen 1500 to close and returns the user to contract summary screen 1300.

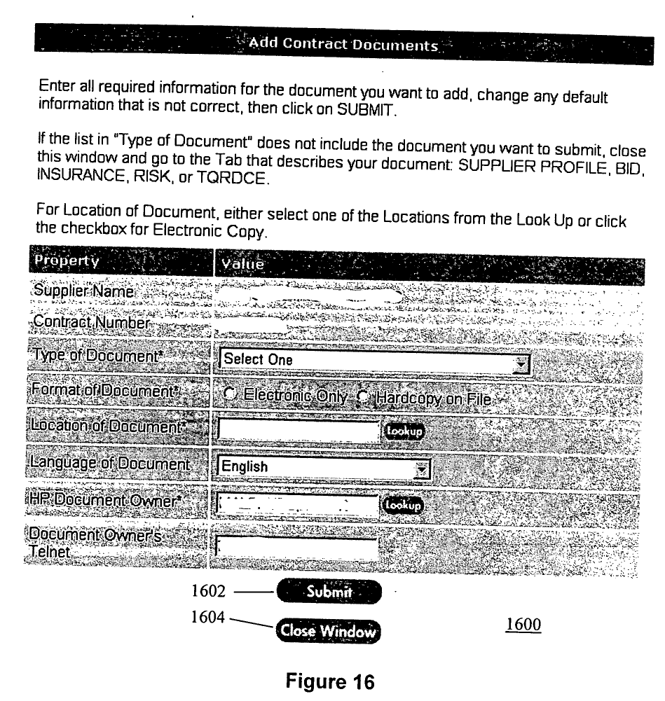

Activation of add contract doc button 1306 causes the generation and display of add contract documents screen 1600 as depicted in FIG. 16 thereby enabling the user to add contract documents related to the supplier to document library 118. The add contract document functionality is also accessible from the add contract link 1204 on screen 1200 of FIG. 12 and is similar to the add profile screen 1000 of FIG. 10.

After the user fills in the contract document parameters, the user activates submit link 1602 and workbench 100 inserts the profile document information into document library 118 and returns the user to contract summary screen 1300. User activation of close window link 1604 causes screen 1600 to close and returns the user to contract summary screen 1300.

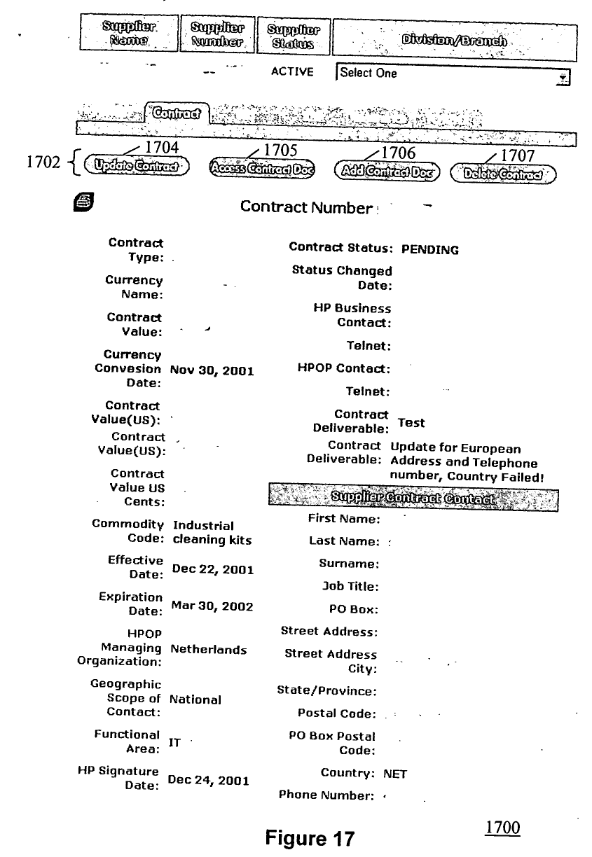

Activation of more contract info button 1307 causes the generation and display of more contract information screen 1700 as depicted in FIG. 17 thereby enabling the user to view additional contract information related to a supplier. A button section 1702 includes a series of buttons 1704-1707 enabling access to additional contract related functionality: an update contract button 1704, an access contract document button 1705, an add contract document button 1706, and a delete contract button 1707. Each of these buttons 1704-1706 has been described above with respect to corresponding buttons 1304-1306 of screen 1300. Delete contract button 1707 is the same as the below-described delete contract button 1308 of screen 1300.

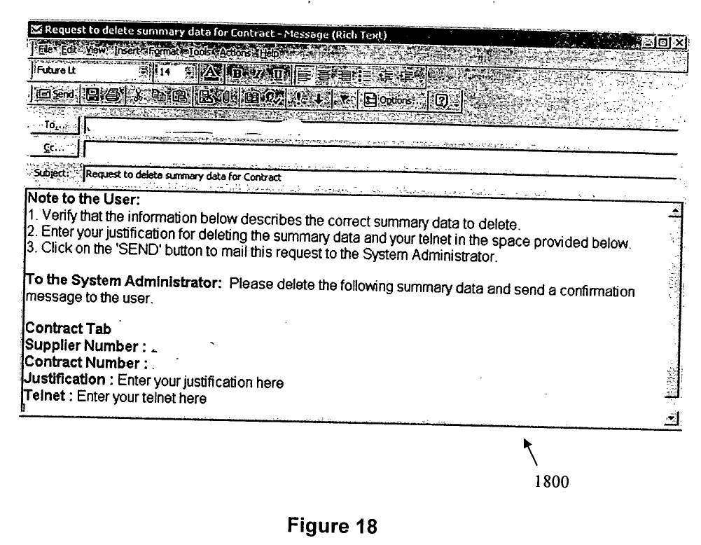

Activation of delete contract button 1308 (or delete contract button 1707 ) causes the generation and display of a delete contract screen 1800 as depicted in FIG. 18 thereby enabling the user to transmit an email requesting deletion of contract information from C/S database 102 by an authorized user. Delete contract screen 1800 may differ depending on the email program used by the user; however, the destination, subject, and body of the message content will be the same. After completion by the user, the user transmits the email message to an authorized user, i.e., the system administrator, using mechanisms known to those skilled in the art. The user is then returned to contract summary screen 1300.

Bid Tab

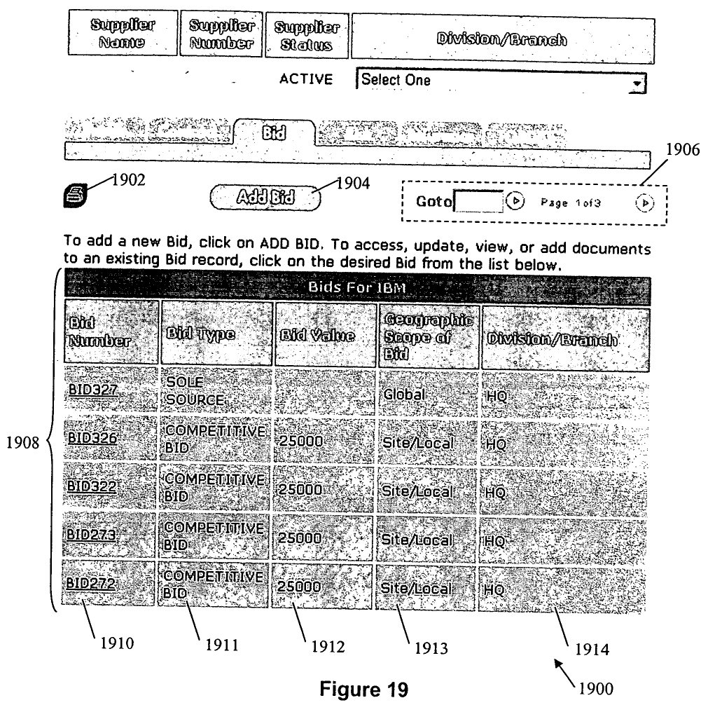

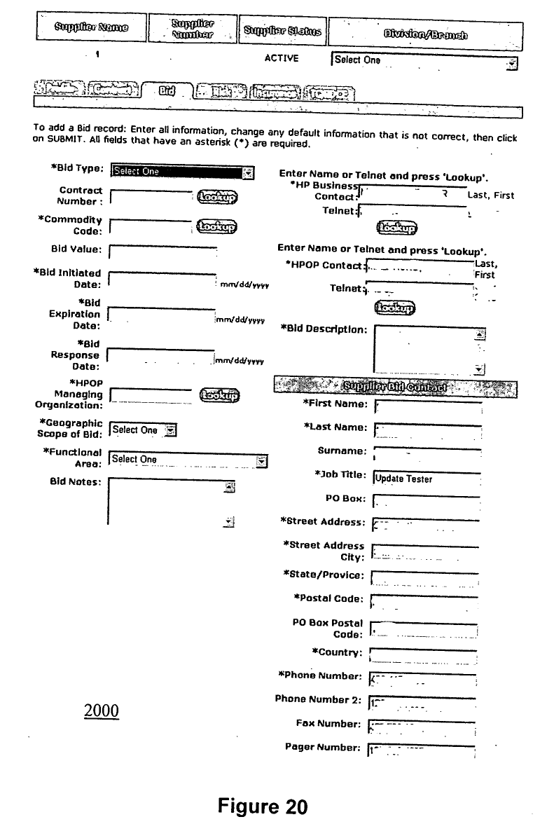

Returning now to FIG. 7, a user activating bid tab 716 causes workbench 100 to display a bid list screen 1900 as depicted in FIG. 19 thereby enabling the user to view a list of bids related to the particular supplier. A print format button 1902 causes the generation and display of a formatted version of bid list screen 1900 in a printer friendly format as described above with respect to screen 700. The user may activate an add bid link 1904 to add a new bid for the specific supplier from workbench 100. Add bid link 1904 functionality is described in detail below in connection with an add bid screen 2000 of FIG. 20. Additional pages of contract lists may be navigated to through the use of navigation controls 1906 (dashed line) as is known in the art.

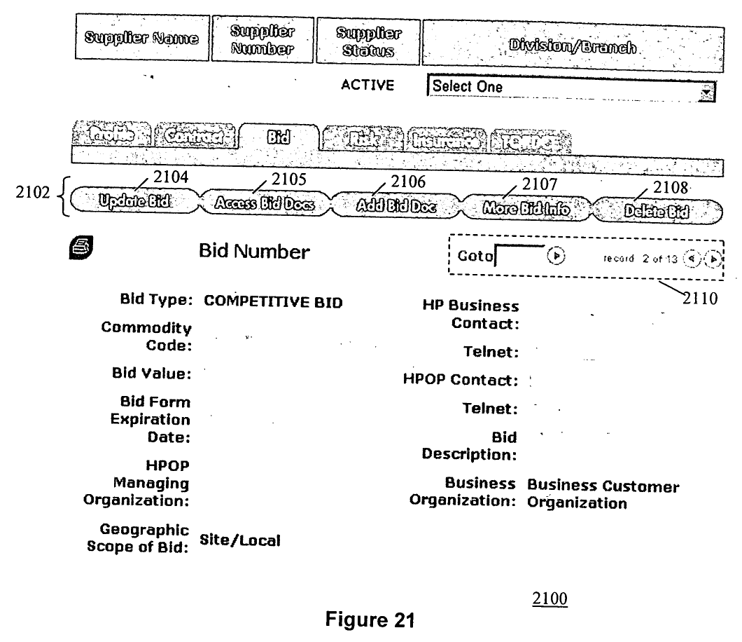

A bid list section 1908 includes a listing of supplier-related bids in table format where the columns include: a bid number column 1910, a bid type column 1911, a bid value column 1912, a geographic scope of bid column 1913, and a division/branch column 1914. Each entry in the bid number column 1910 includes an activatable link for causing display of summary level information of the particular bid as described below in connection with a bid summary screen 2100 of FIG. 21.

Add bid screen 2000 of FIG. 20 includes input fields for capturing information related to a supplier bid, e.g., bid type, contract number, commodity code, bid value, bid initiated date, bid expiration date, bid response date, good and service procurement managing organization, geographic scope of bid, and so on. Additionally, workbench 100 fills in default values for supplier bid contact information fields. The user may modify the default values specific to the bid. A submit button and a close window button (not shown) may be activated as described above in order to submit the bid information or clear the bid information fields without submitting the information to C/S database 102. The user is then returned to bid list screen 1900.

Bid summary screen 2100 includes summary information related to a particular supplier bid. A button section 2102 includes a series of buttons 2104-2108 enabling access to additional supplier bid related functionality: an update bid button 2104, an access bid documents button 2105, an add bid document button 2106, a more bid info button 2107, and a delete bid button 2108. A print format button 2109 causes the generation and display of a formatted version of bid summary screen 2100 in a printer friendly format as described above with respect to screen 700. Additional pages of bid summary information may be navigated to through the use of navigation controls 2110 (dashed line) as is known in the art.

The remainder of summary screen 2100 includes summary bid information including bid type, bid value, commodity code of the bid, bid form expiration date, good and service procurement managing organization, geographic scope of the bid, business contact and telephone, good and service procurement contact and telephone, and bid description.

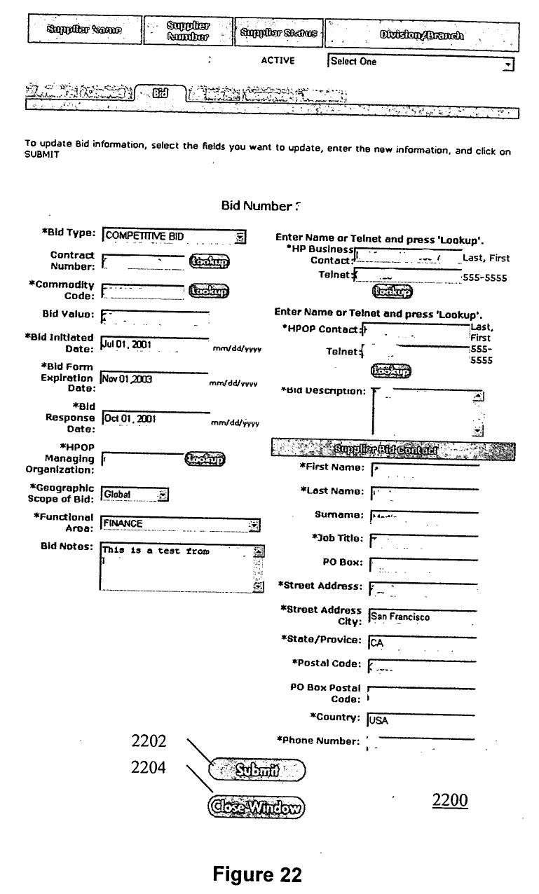

Activation of update bid button 2104 in bid summary screen 2100 causes the generation and display of update bid screen 2200 as depicted in FIG. 22 enabling the user to modify supplier bid related information. After modifying information, the user activates a submit link 2202 to cause entry of the information into C/S database 102. Alternatively, the user may activate close window link 2204 to cause screen 2200 to close and return the user to bid summary screen 2100.

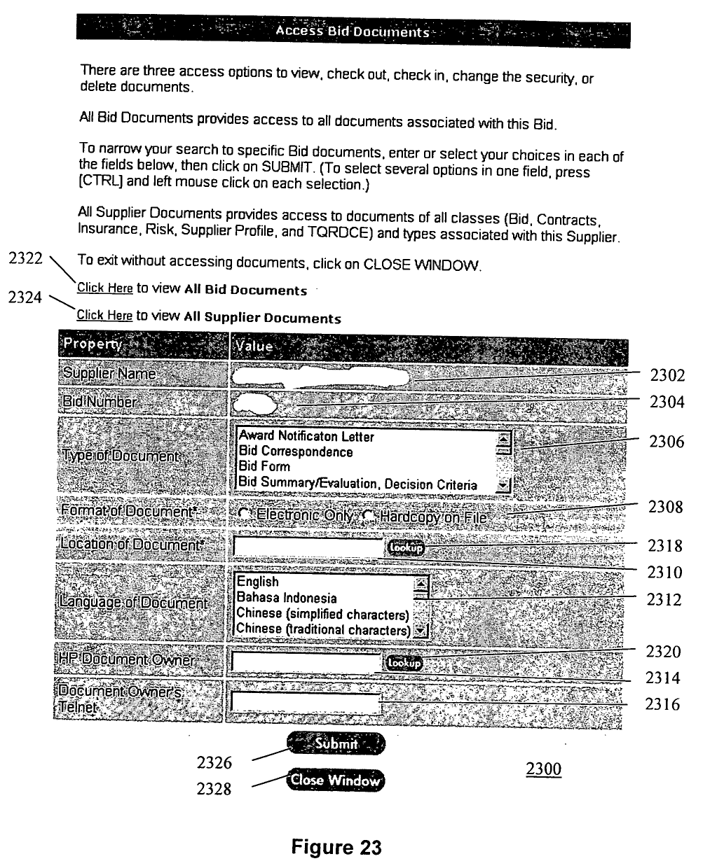

Activation of access bid docs button 2105 causes the generation and display of access bid documents screen 2300 as depicted in FIG. 23 thereby enabling the user to access bid documents related to the supplier from document library 118 similar to access profile documents screen 900 described in detail above. Access bid documents screen 2300 includes a supplier name field 2302 for displaying the supplier name, a bid number field 2304 for displaying the bid number, a document type list 2306 for selecting a particular document type for which to search, a document format button 2308 for specifying a particular document format for which to search, a document location field 2310 for specifying a particular location for which to search, a document language list 2312 for specifying a particular document language for which to search, a document owner field 2314 for specifying a particular document owner for which to search, and an owner telephone field 2316 for specifying a particular telephone of a document owner for which to search. Additionally, document location field 2310 and document owner field 2314 include corresponding lookup links 2318, 2320 enabling entry of the information by accessing a lookup screen (not shown).

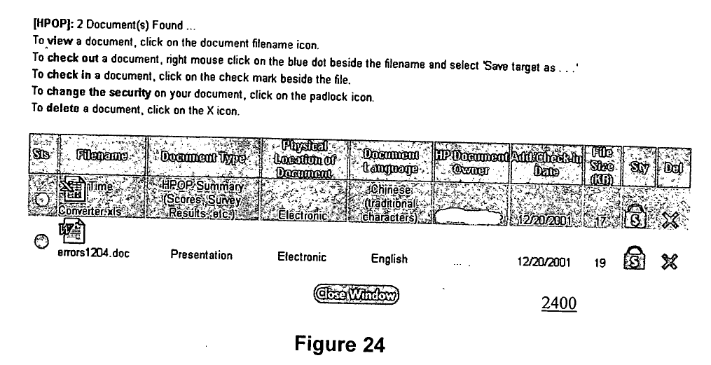

User activation of an all bid documents link 2322 causes the generation and display of all bid documents screen 2400 as depicted in FIG. 24 thereby enabling user access to all bid documents associated with the current bid. User activation of an all supplier documents link 2324 causes the generation and display of an all supplier documents screen (not shown) similar to the all bid documents screen 2400 thereby enabling user access to all supplier documents associated with the current supplier.

After the user fills in desired search parameters, the user activates submit link 2326 and workbench 100 executes a search of document library 118 and returns matching documents and/or document references in a list (not shown) to the user for viewing. User activation of close window link 2328 causes screen 2300 to close and returns the user to bid summary screen 2100.

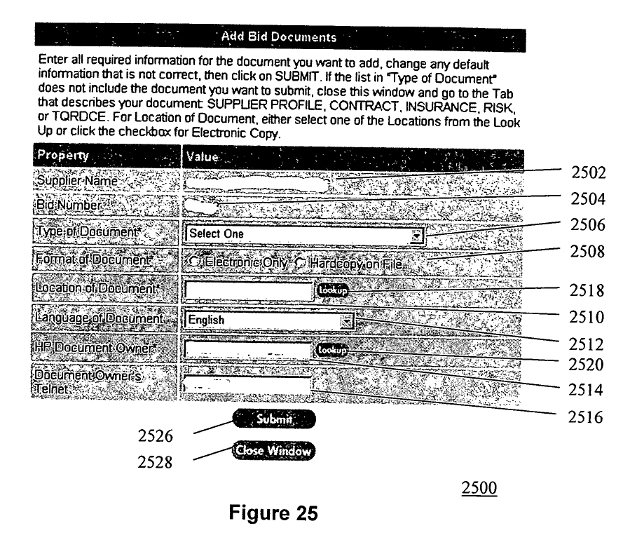

Activation of add bid doc button 2106 causes the generation and display of add bid documents screen 2500 as depicted in FIG. 25 thereby enabling the user to add bid documents related to the supplier to document library 118. The add contract document functionality is also accessible from the add bid link 1904 on screen 1900 of FIG. 19 and is similar to the add profile screen 1000 of FIG. 10.

After the user fills in the bid document parameters, the user activates submit link 2526 and workbench 100 inserts the bid document information into document library 118 and returns the user to bid summary screen 2100. User activation of close window link 2528 causes screen 2500 to close and returns the user to bid summary screen 2100.

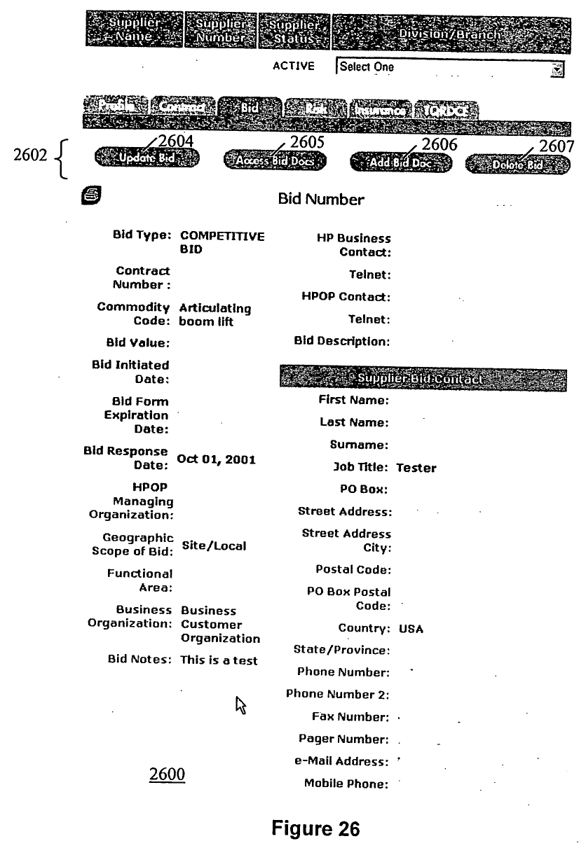

Activation of more contract info button 2107 causes the generation and display of more bid information screen 2600 as depicted in FIG. 26 thereby enabling the user to view additional bid information related to a supplier. A button section 2602 includes a series of buttons 2604-2607 enabling access to additional bid related functionality: an update bid button 2604, an access bid document button 2605, an add bid document button 2606, and a delete bid button 2607. Each of these buttons 2604-2606 has been described above with respect to corresponding buttons 2104-2106 of screen 2100. Delete bid button 2607 is the same as the below-described delete bid button 2108 of screen 2100.

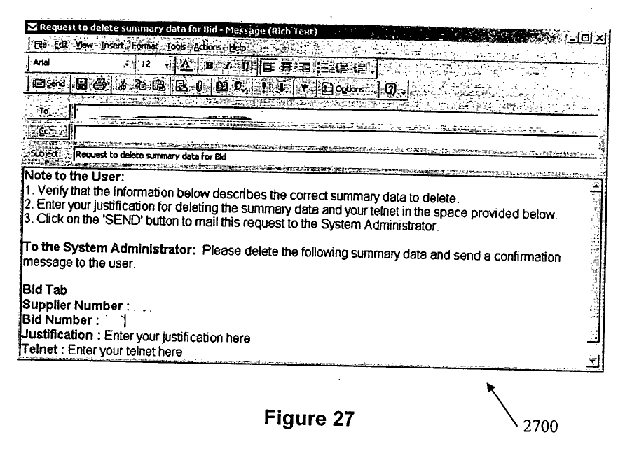

Activation of delete bid button 2108 (or delete bid button 2607 ) causes the generation and display of a delete bid screen 2700 as depicted in FIG. 27 thereby enabling the user to transmit an email requesting deletion of bid information from C/S database 102 by an authorized user. Delete bid screen 2700 may differ depending on the email program used by the user; however, the destination, subject, and body of the message content will be the same. After completion by the user, the user transmits the email message to an authorized user, i.e., the system administrator, using mechanisms known to those skilled in the art. The user is then returned to bid summary screen 2100.

Risk Tab

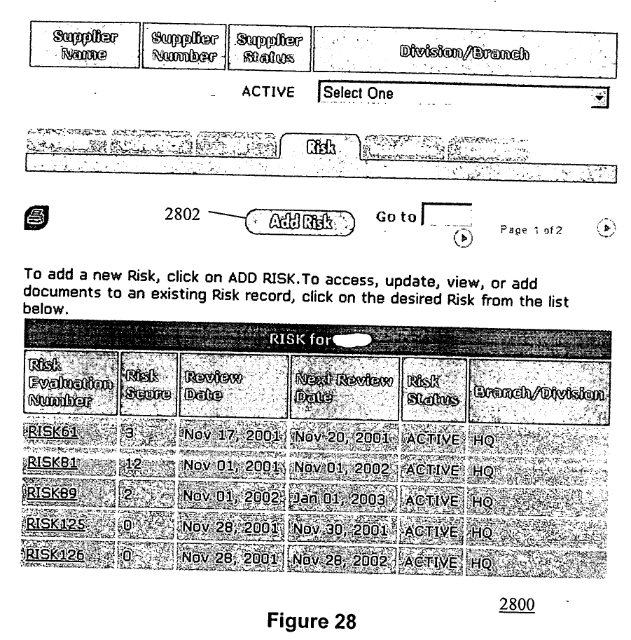

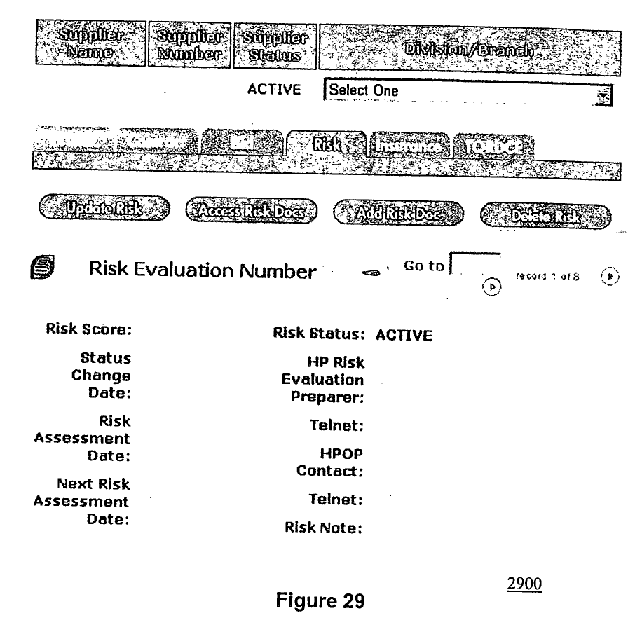

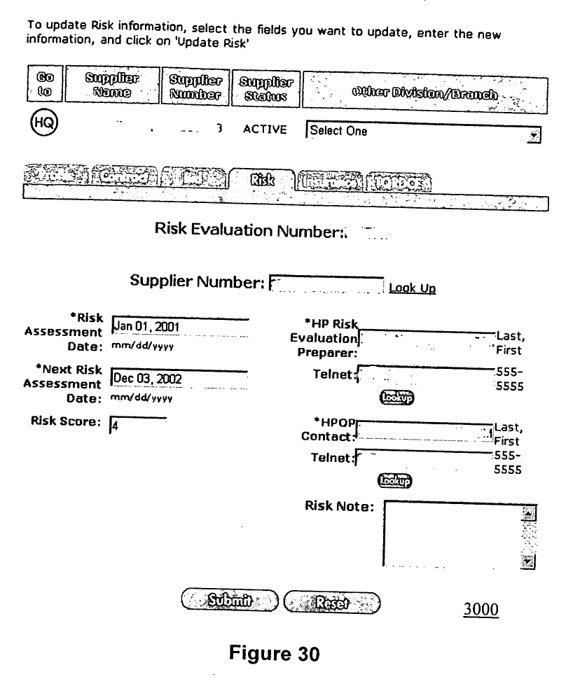

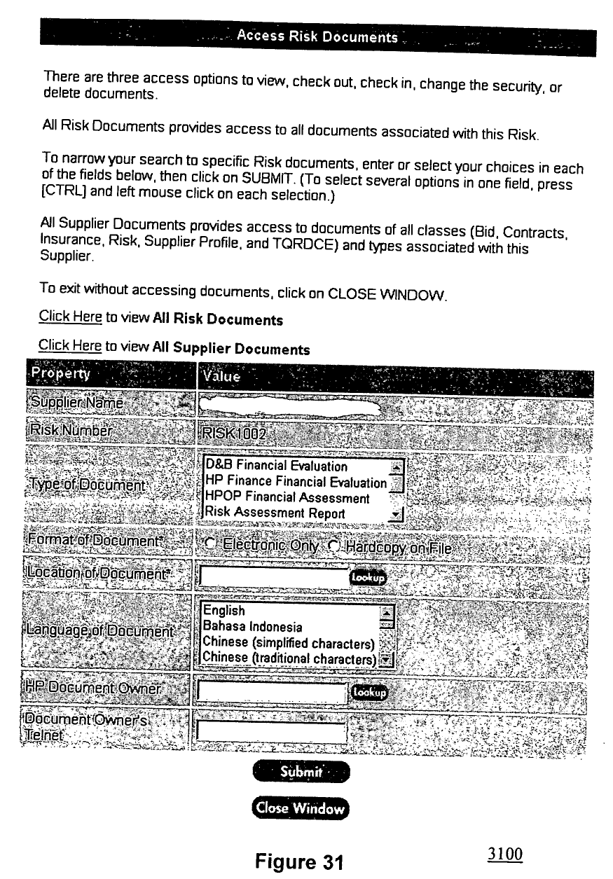

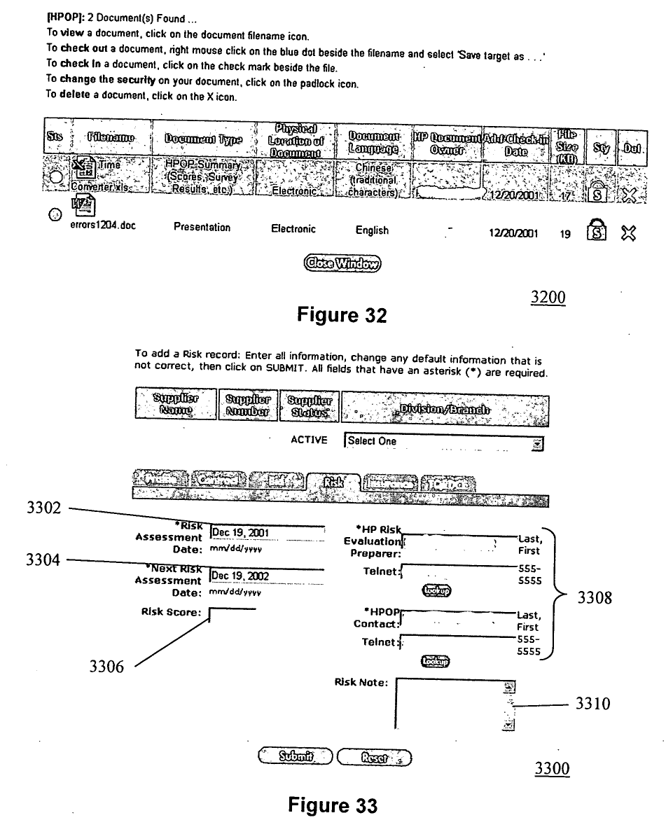

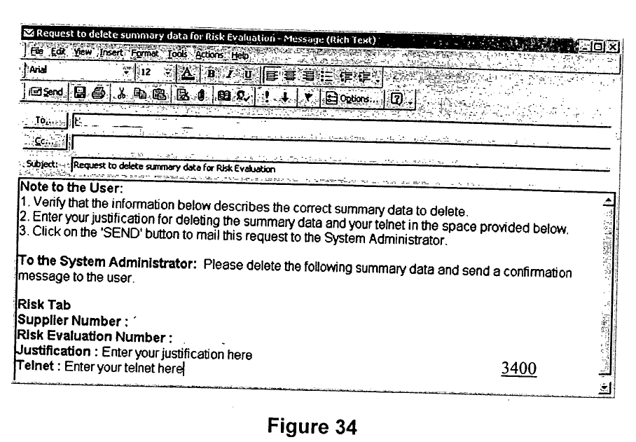

Returning now to FIG. 7, a user activating risk tab 717 causes workbench 100 to display a risk list screen 2800 as depicted in FIG. 28 thereby enabling the user to view a list of risk entries related to the particular supplier. Risk list screen 2800 is similar in layout and functionality as bid list screen 1900 described above with respect to FIG. 19. Further, risk summary screen 2900 (FIG. 29), update risk screen 3000 (FIG. 30), access risk screen 3100 (FIG. 31), all risk documents screen 3200 (FIG. 32), and delete risk screen 3400 (FIG. 34) are all substantially similar in functionality and layout to corresponding bid-related screens 2100, 2200, 2300, 2400, and 2700. Further detailed description is believed unnecessary and it is believed that, in context, the screens 2800, 2900, 3000, 3100, 3200, and 3400 will be understood by persons skilled in the art.

A user activating an add risk button 2802 on screen 2800, causes the generation and display of add risk record screen 3300 of FIG. 33 thereby enabling the user to input a risk record related to the particular supplier in C/S database 102. Add risk record screen 3300 includes a risk assessment date field 3302, a next risk assessment date field 3304, a risk score field 3306, a contact information section 3308, and a risk note field 3310.

Insurance Tab

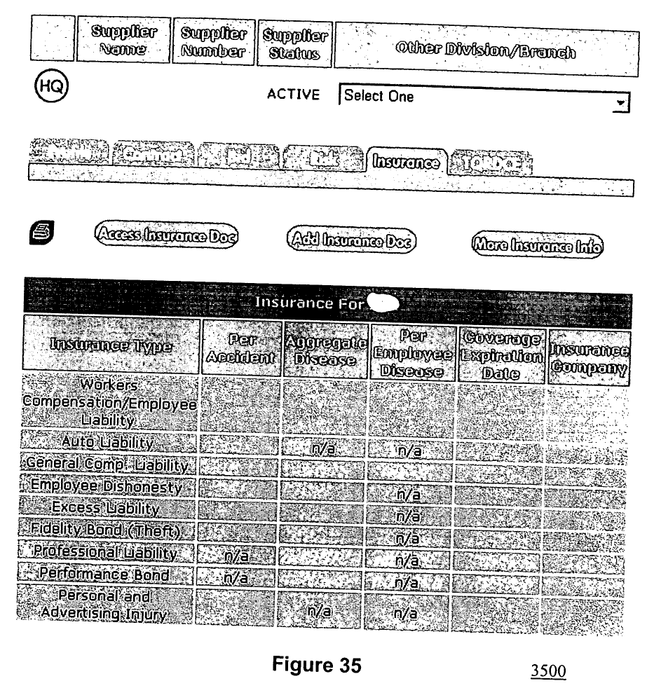

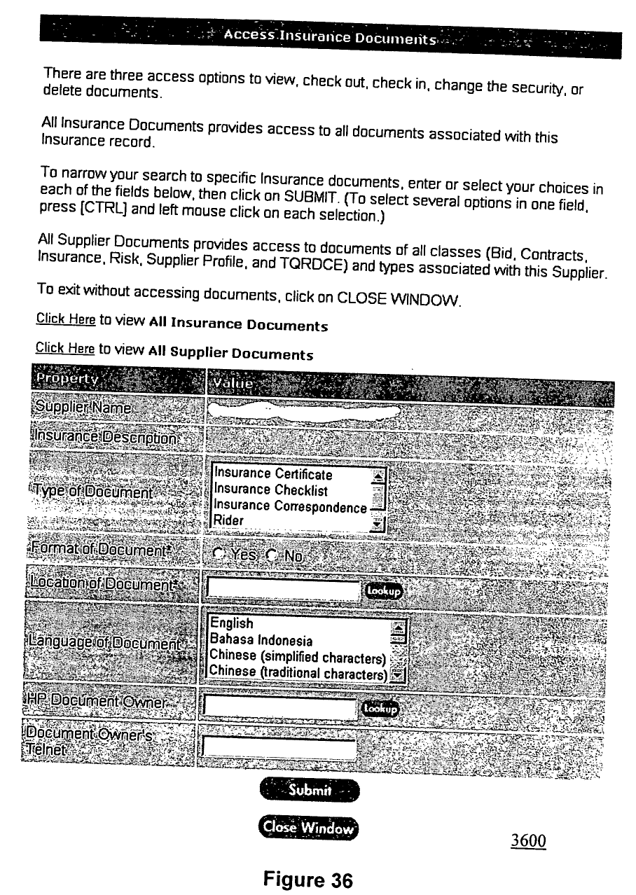

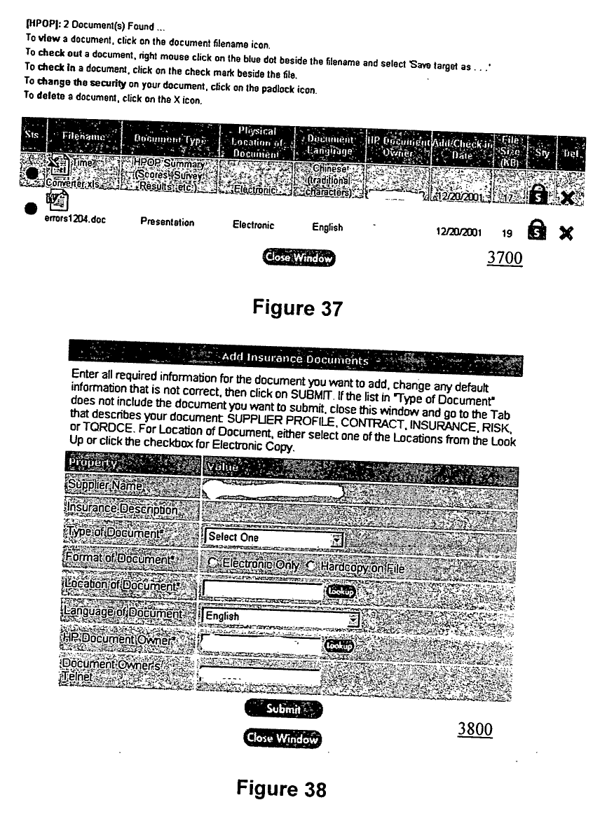

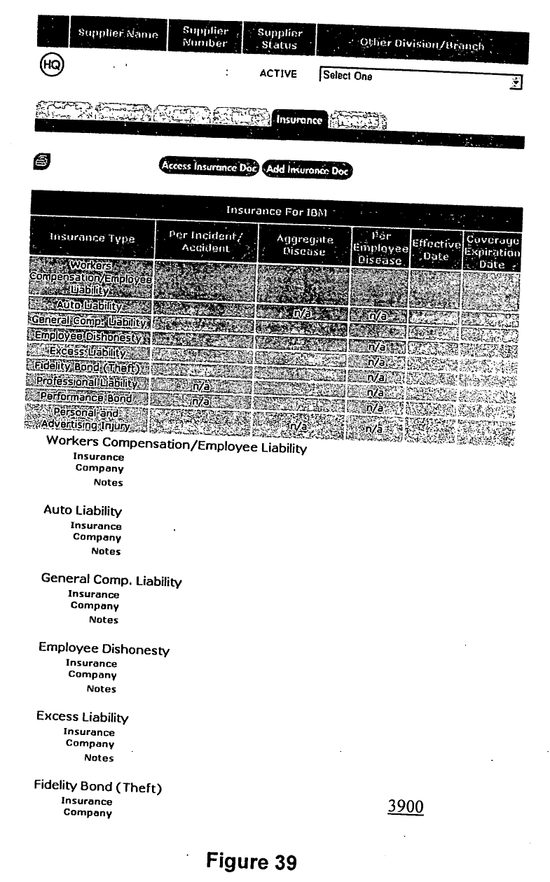

Returning now to FIG. 7, a user activating insurance tab 718 causes workbench 100 to display an insurance summary screen 3500 as depicted in FIG. 35 thereby enabling the user to view a summary of insurance information related to the particular supplier. Insurance summary screen 3500 is similar in layout and functionality to bid summary screen 2100 described above with respect to FIG. 21. Further, access insurance screen 3600 (FIG. 36), all insurance documents screen 3700 (FIG. 37), add insurance documents screen 3800 (FIG. 38), and more insurance information screen 3900 (FIG. 39) are all substantially similar in functionality and layout to corresponding bid-related screens 2300, 2400, 2500, and 2600. Further detailed description is believed unnecessary and it is believed that, in context, the screens 3500, 3600, 3700, 3800, and 3900 will be understood by persons skilled in the art.

TQRDCE Tab

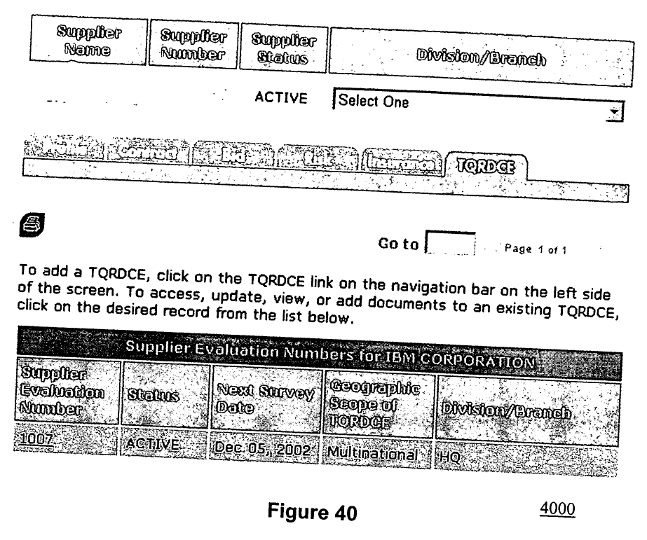

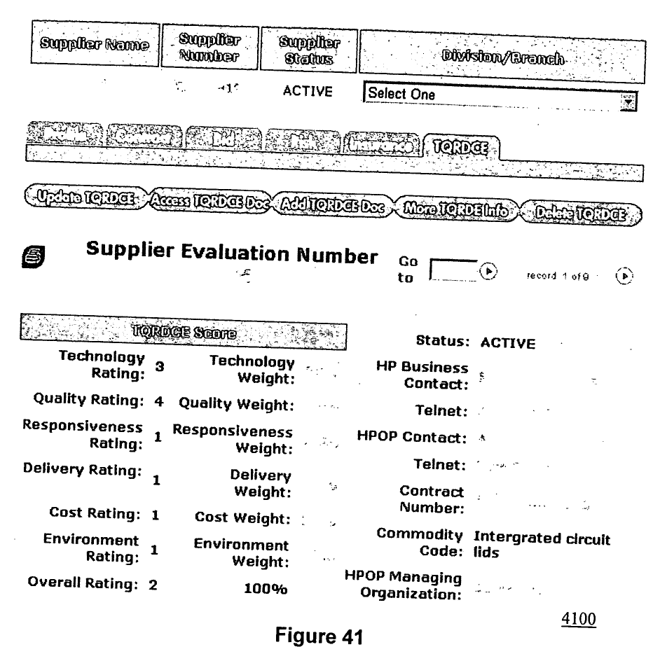

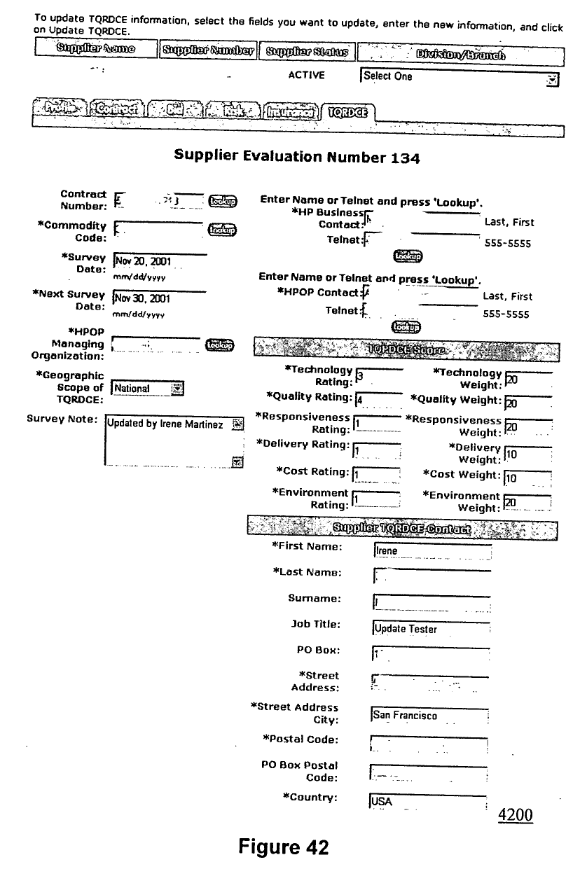

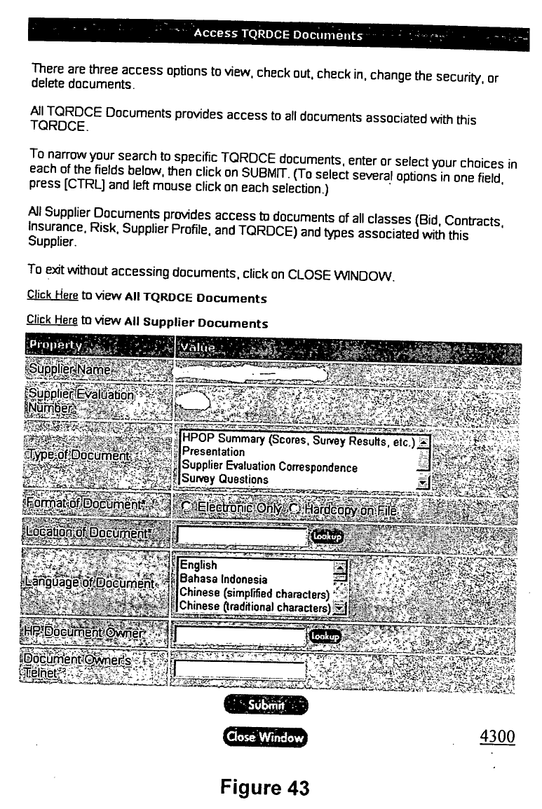

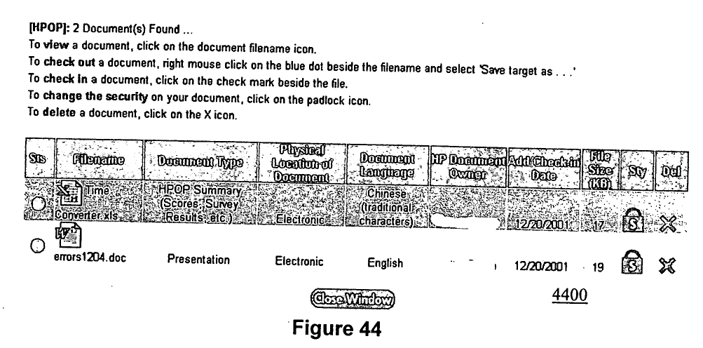

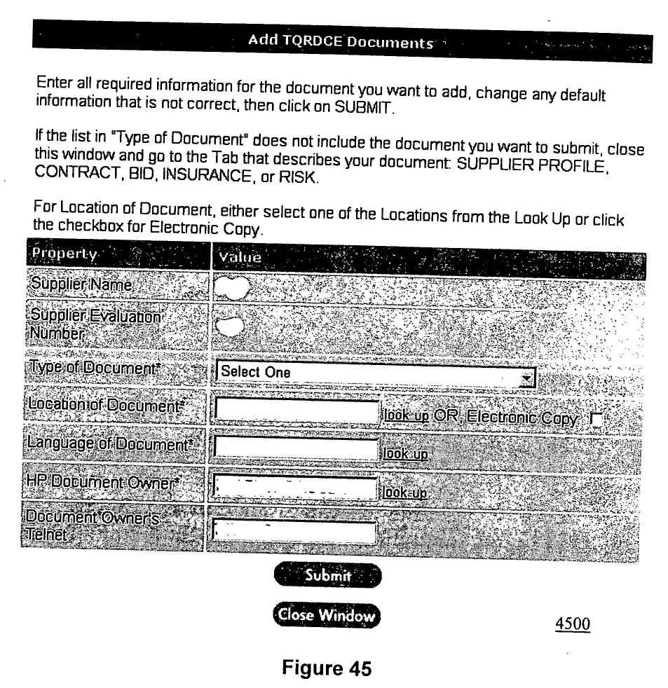

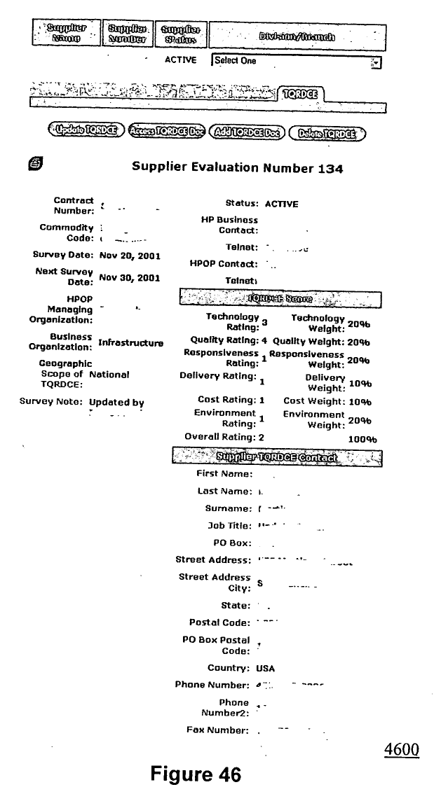

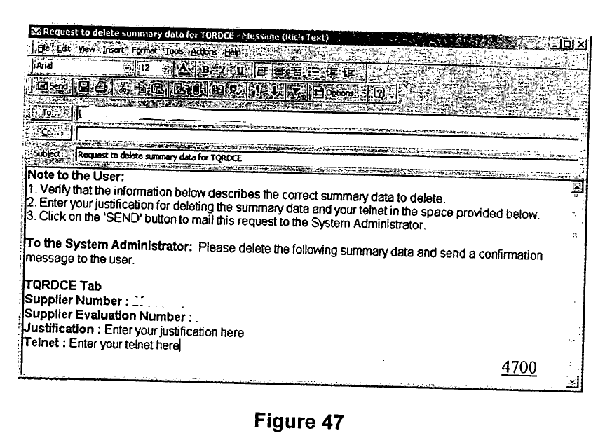

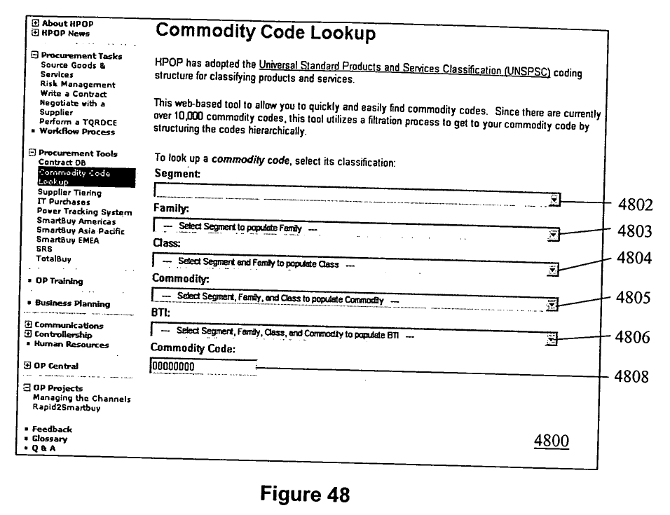

Returning now to FIG. 7, a user activating TQRDCE tab 719 causes workbench 100 to display a TQRDCE list screen 4000 as depicted in FIG. 40 thereby enabling the user to view a list of TQRDCE entries related to the particular supplier. TQRDCE list screen 4000 is similar in layout and functionality to bid list screen 1900 described above with respect to FIG. 19. Further, TQRDCE summary screen 4100 (FIG. 2941), update TQRDCE screen 4200 (FIG. 42), access TQRDCE screen 4300 (FIG. 43), all TQRDCE documents screen 4400 (FIG. 44), add TQRDCE documents screen 4500 (FIG. 45), more TQRDCE information screen 4600 (FIG. 46), and delete TQRDCE screen 4700 (FIG. 47) are all substantially similar in functionality and layout to corresponding bid-related screens 2100, 2200, 2300, 2400, 2500, 2600, and 2700. Further detailed description is believed unnecessary and it is believed that, in context, the screens 4100, 4200, 4300, 4400, 4500, 4600, and 4700 will be understood by persons skilled in the art.

Returning now to FIG. 5, supplier number search field 509 enables a user to search for information related to a particular supplier by entering all or part of a supplier number, i.e., identifier and activating submit link 512. Responsive to a supplier number search entry by the user and activation of submit link 512, workbench 100 searches entries in C/S database 102 for a supplier entry having a matching name. If a matching entry is found, profile screen 700 is again displayed to the user as described above. If more than one matching entry is found, a list of the matching entries is displayed to the user enabling the user to select one of the entries in the list or return to GUI 500 and modify the search. If no matching entry is found, a message displayed to the user details the lack of a match and the user is returned to GUI 500.

Commodity code search field 510 enables a user to search for a supplier based on commodity code by entering all or part of a commodity code and activating submit link 512. Responsive to a commodity code search entry by the user and activation of submit link 512, workbench 100 searches entries in C/S database 102 for a supplier entry having a matching commodity code. If a matching entry is found, profile screen 700 is again displayed to the user as described above. If more than one matching entry is found, a list of the matching entries is displayed to the user enabling the user to select one of the entries in the list or return to GUI 500 and modify the search. If no matching entry is found, a message displayed to the user details the lack of a match and the user is returned to GUI 500. Additionally, the user may activate a commodity code lookup link 514 to determine a commodity code to be entered in commodity code search field 510 using a commodity code lookup screen 4800.

Commodity code lookup screen 4800 includes a segment drop-down menu 4802, a family drop-down menu 4803, a class drop-down menu 4804, a commodity drop-down menu 4805, and a BTI drop-down menu 4806. A user sequentially activates each drop-down menu 4802-4805 thereby causing the population of the contents of the next sequential drop-down menu 4803-4806. User activation of BTI drop-down menu 4806 causes a properly formed commodity code value to be populated by workbench 100 into a commodity code field 4808. The commodity code value may then be copied and pasted into other fields, e.g., commodity code field 510 of screen 500, as is known to persons of skill in the art.

Contract number search field 511 enables a user to search for a supplier based on a contract number by entering all or part of a contract number and activating submit link 512. Responsive to a contract number search entry by the user and activation of submit link 512, workbench 100 searches entries in C/S database 102 for a supplier entry having a matching contract number. If a matching entry is found, profile screen 700 is again displayed to the user as described above. If more than one matching entry is found, a list of the matching entries is displayed to the user enabling the user to select one of the entries in the list or return to GUI 500 and modify the search. If no matching entry is found, a message displayed to the user details the lack of a match and the user is returned to GUI 500.

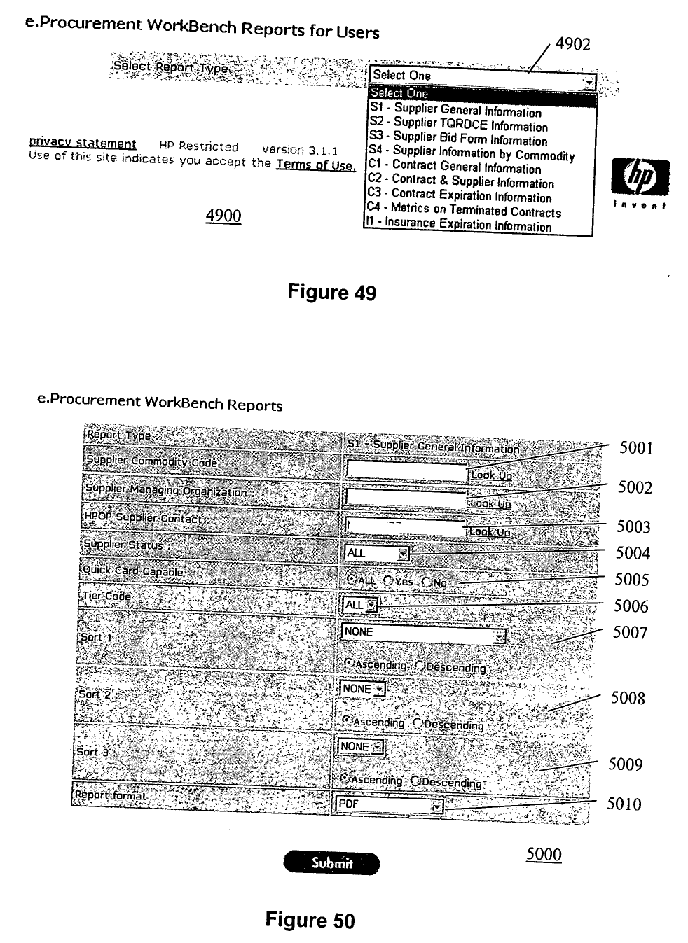

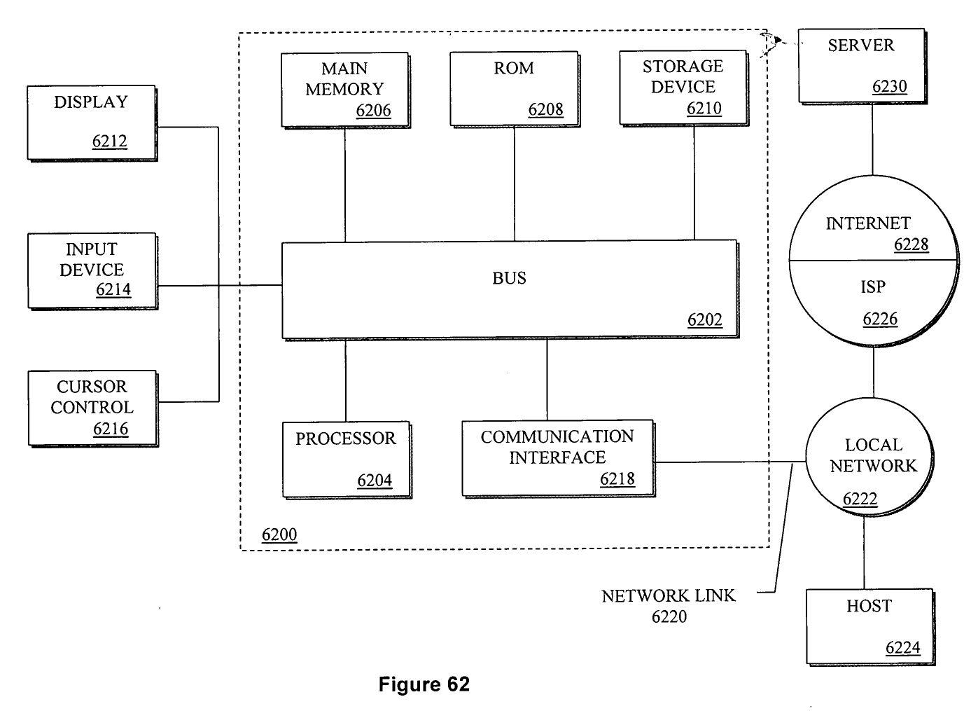

With reference to FIG. 6, navigation bar 502 includes multiple activatable links enabling a user to navigate between and among different functional areas of workbench 100. A good and service procurement home link 602 when activated by a user, causes the good and service procurement web portal object 104 to display the top level GUI (not shown) for the Indirect/Services Procurement system, i.e., activation of the link takes the user to the destination identified by the link as is known to those of skill in the art. In a similar manner, activation of eProcurement Workbench home link 604 returns the user to GUI 500, i.e., web portal object 104 causes the display of GUI 500 on the computer system display 6212 (described below with reference to FIG. 62) of the user. A user reports link 606 enables access to user report functionality as depicted in user report selection screen 4900 of FIG. 49.

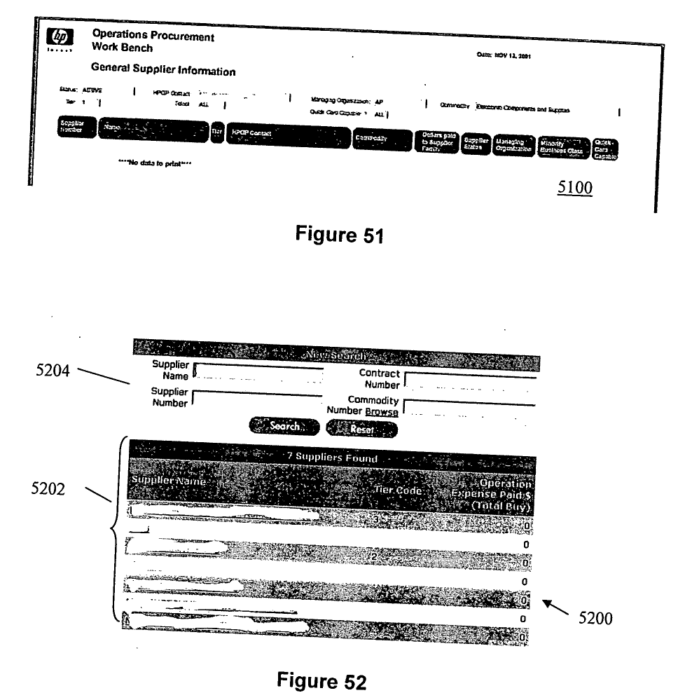

User report selection screen 4900 includes a user report type selection drop-down menu 4902 for selecting the type of report the user desires to view. For example, after selection of the “Supplier General Information” report menu item by the user using the drop-down menu 4902, workbench 100 causes the generation of supplier general information report specification screen 5000 of FIG. 50. Supplier general information report specification screen 5000 includes a supplier commodity code field 5001, a supplier managing organization field 5002, an good and service procurement supplier contact field 5003, a supplier status drop-down menu 5004, a quick card capable radio field 5005, a tier code drop-down menu 5006, a first sort specification section 5007 for specifying a sort field and order for the information in the generated report, a second sort specification section 5008, a third sort specification section 5009, and a report format drop-down menu 5010 for specifying the report output format, e.g., text, portable document format, or other report formats. After specifying the desired report format and information, the user activates a submit link 5012, i.e., a submit button, causing the generation and display of general supplier information report screen 5100 of FIG. 51.

A workbench tools section 608 of navigation bar 502 includes several links 610-615 enabling access to functionality integrated into the procurement workbench 100. A commodity code lookup link 610 enables access to a commodity code lookup functionality for classifying products and services. The commodity code lookup screen 800 is described above.

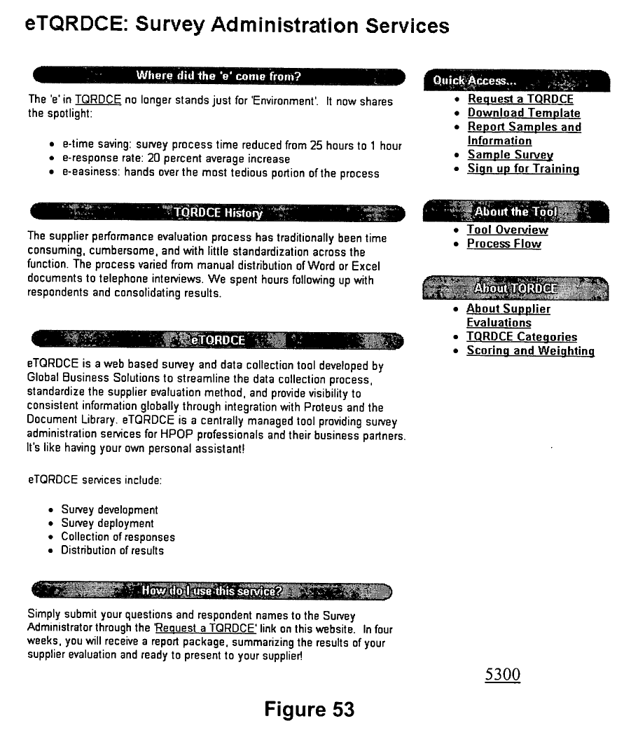

An eTQRDCE link 611 enables access to electronic technology, quality, responsiveness, delivery, cost, and environment evaluation of suppliers, and information regarding the methodology for evaluating suppliers. eTQRDCE screen 5300 of FIG. 53 depicts an example screen displayed by activation of eTQRDCE link 611.

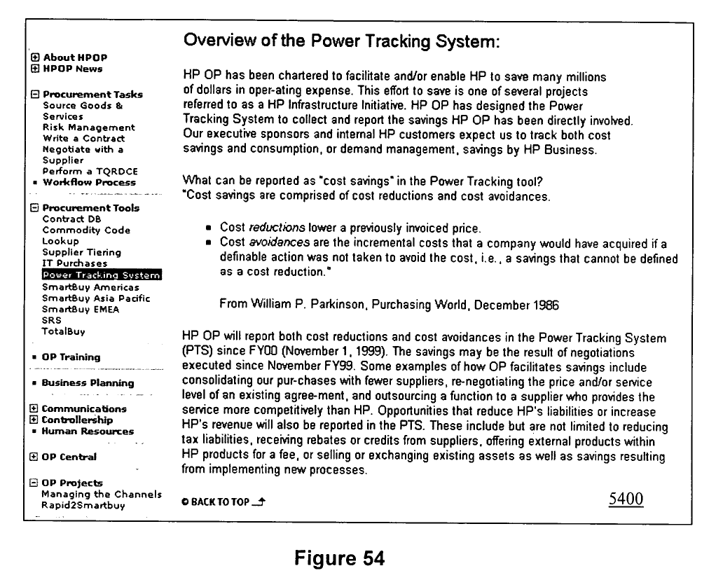

A value tracking system link 612 enables access to value tracking functionality including procurement process savings strategies. Value tracking system screen 5400 of FIG. 54 depicts an example screen displayed by activation of value tracking system link 612.

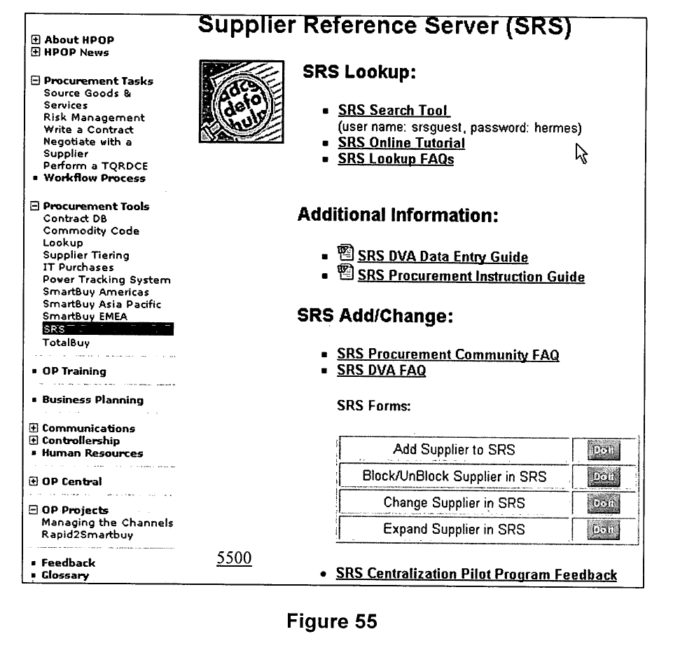

An SRS link 613 enables access to the supplier reference server functionality. SRS screen 5500 of FIG. 55 depicts an example screen displayed by activation of SRS link 613.

A supplier tiering link 614 enables access to supplier tiering guidelines and supporting commodity teams and geographies. Supplier tiering screen 5600 of FIG. 56 depicts an example screen displayed by activation of supplier tiering link 614.

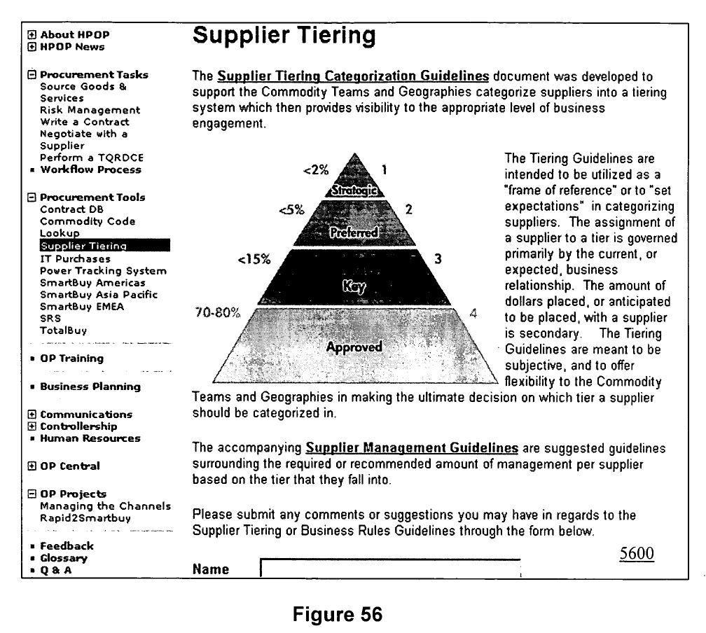

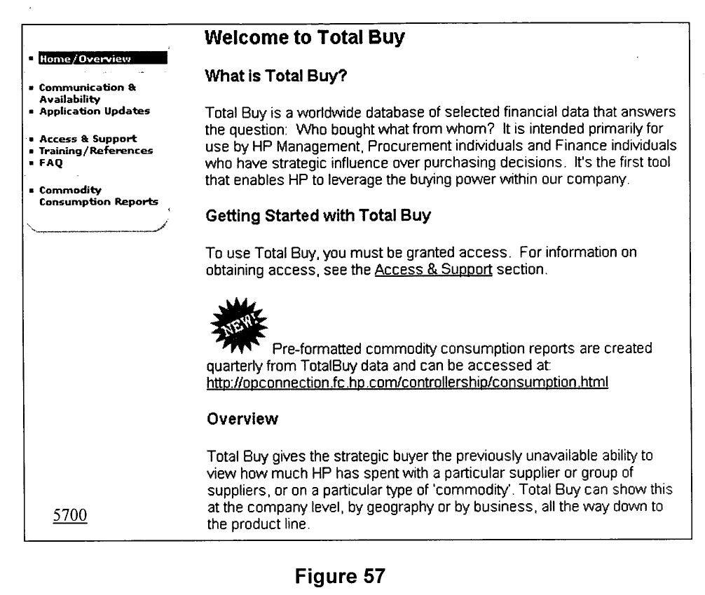

A total buy link 615 enables access to selected financial data regarding suppliers. total buy screen 5700 of FIG. 57 depicts an example screen displayed by activation of total buy link 615.

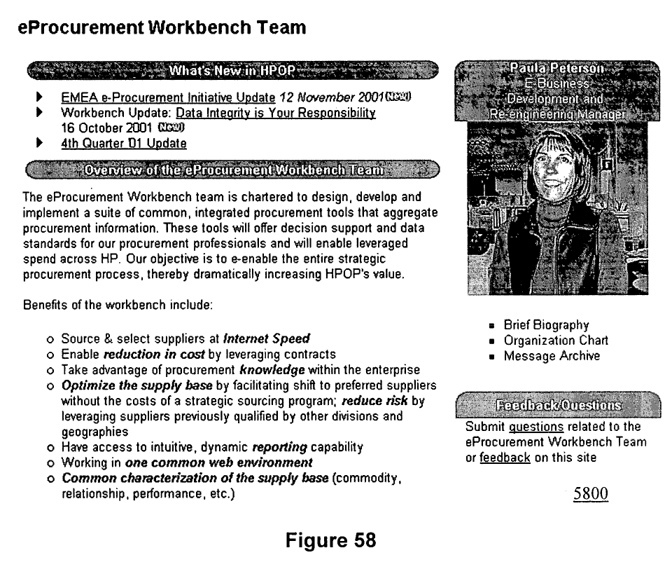

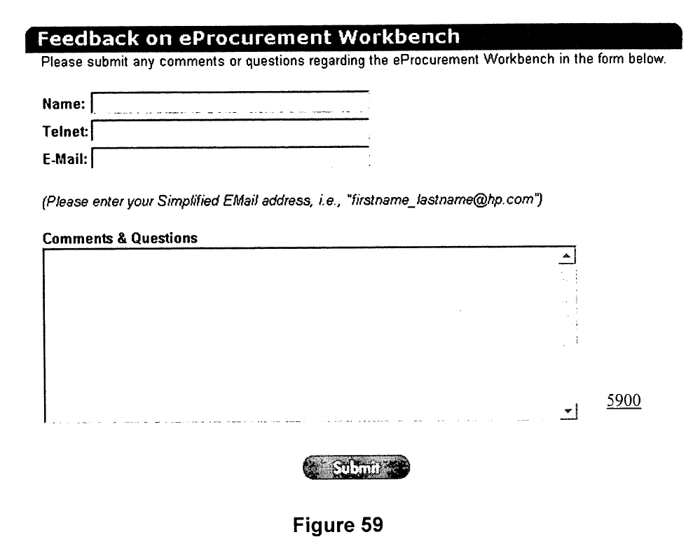

A workbench team link 616 enables access to information related to the creators of workbench 100. Workbench team screen 5800 of FIG. 58 depicts an example screen displayed by activation of workbench team link 616. A feedback link 618 enables access to mechanisms for providing feedback regarding workbench 100 to appropriate personnel. Feedback screen 5900 of FIG. 59 depicts an example screen displayed by activation of feedback link 618. A FAQ (frequently asked questions) link 620 enables access to a compilation of frequently requested information regarding workbench 100.

Central Administrator Object

Returning now to FIG. 1, central administrator object 108 enables access to administrative users to maintenance and report functionality of the procurement workbench 100.

Admin reports are available and should be created for the following types and features:
Pull down table report—There is a report for each pull down table that includes both historical and current codes/descriptions
Audit report-An Audit report where information changes for a single supplier can be logged with adds, updates, deletes, date changed, what changed, and who changed it by supplier. Report data for a supplier will be kept for a rolling 12 months.
Contract expiration date report-When Contract Status equals Expired, a report is generated to Supplier/Contract Management Admin. This is a report that can be run monthly.

If the Insurance Coverage Status equals Active 30 days before Coverage Expiration Date, an Insurance coverage expiration date report is generated for Workbench Admin.

At Coverage Expiration Date, a report is generated for Workbench Admin.

When a contract has a status of active, a Workbench Admin report, as a one-time occurrence, is generated under the following conditions:
Where Contract Status equals Active;
Good and Service Procurement Current Contact in Contract changes manager;
Current Business Contact changes manager;
Good and Service Procurement Current Contact in Contract changes Organization;
Current Business Contact changes Organization; and
Good and Service Procurement Current Contact in Contract changes physical location.

Business signature date report—If the business Signature Date is missing 30 days after Effective Date, a report for Workbench Admin is generated.

The Supplier Status is moved to Inactive when Total Buy dollars for last 12 months=0, and:
There are no Contracts in an Active status; and
There are no Bid documents in an Active status.

A report is generated for the Workbench Admin to initiate the Blocking of the supplier on SRS when Total Buy dollars for last 24 months=0, and:
There are no Contracts in an Active status; and
There are no Bid documents in an Active status.

After a supplier information is input from SRS as blocked or deleted and Workbench status for the supplier does not equal blocked/deleted, an SRS investigative report for Workbench Admin is created to either start the archiving process or investigate why the supplier was blocked.

After a commodity code is deleted from the new Commodity Code source file feed and that commodity code exists in our system for a supplier in contract or other summary data, a commodity code investigative report is created for the Workbench Admin.

After the Workbench Admin deletes a record, a record deleted report is generated for the Document Library Admin and Audit to maintain consistency between documents and metadata and to provide for audit history.

After a supplier name changes in SRS, a name changed in SRS report is created for the Workbench Admin.

If all TQRDCEs are Expired for a tier 1 or 2 supplier, a supplier tier 1 or 2 expiration report is generated for the TQRDCE Admin listing any tier 1 or 2 supplier.

If there are no TQRDCEs on file, and a supplier's tier code equals 1 or 2, a supplier tier 1 or 2 nothing on file report is generated to the TQRDCE Admin listing the suppliers (when today's date equals the supplier's tier code change date plus 366 days).

A Supplier Tier 1 or 2 no active risk evaluations report is generated for the Workbench Admin, where all the Risk Evaluations are expired (there are no Active Risk Evaluations) for a particular tier 1 or 2 supplier.

After an Good and Service Procurement Current Contact in Contract is terminated (no longer on ED) 30 days after a notification is sent, if this employee still exists in the Contract table, a terminated employee still listed in contract table report for the Workbench Admin is generated.

After an Current Business Contact is terminated (no longer on ED) 30 days after notification is sent, if this employee still exists in the Contract table, a report for the Workbench Admin is generated.

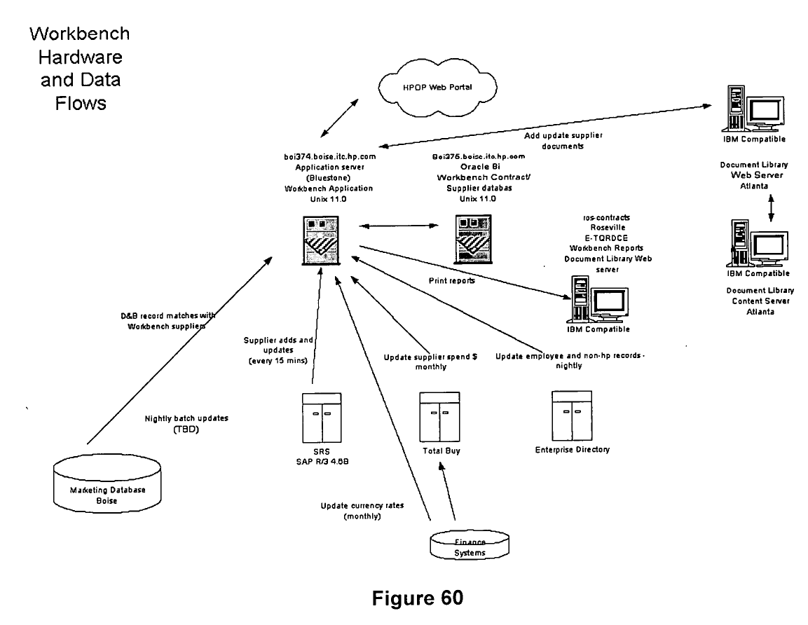

FIG. 60 is a high level diagram of hardware components and a flow of data between the various hardware components of an exemplary embodiment according to the present invention. Additionally, exemplary information update rates are provided, as well.

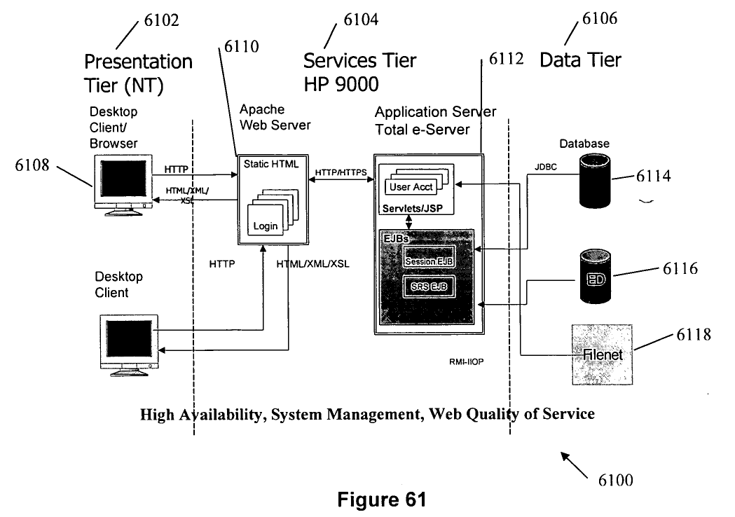

FIG. 61 is a high level block diagram of a three tier view of an exemplary embodiment according to the present invention. The three tiers include a presentation tier 6102 for presenting access and information to a user of the workbench 100, a services tier 6104 for presenting a user interface and performing processing on the data contained in the workbench, and a data tier 6106 for providing access to and storing the data of the workbench.

Presentation tier 6102 includes a desktop client 6108, e.g., a computer system, having a browser software for accessing services tier 6104. As depicted in FIG. 61, desktop client 6108 communicates with services tier 6104 using communication protocols, e.g., HTTP, and receives information formatted for display in the browser, e.g., HTML, XML, and XSL.

Services tier 6104 includes a web server 6110, e.g., an APACHE-based web server, and an application server 6112. Web server 6110 responds to requests from desktop client 6108 and requests information from application server 6112 for responding to desktop client requests. Application server 6112 responds to requests from web server 6110 and requests information from and provides information to data tier 6106 in order to respond to the web server. Web server 6110 and application server 6112 communicate using standard protocols, e.g., HTTP and HTTPS.

Data tier 6106 includes a database 6114, an enterprise directory data store 6116, and a filenet data store 6118. Each of the data storage facilities of data tier 6106 is responsive to requests and information provided to/from services tier 6104.

FIG. 62 is a block diagram depicting an exemplary computer or user device 6200, e.g. a computer system, upon which an embodiment of the invention may be implemented. The present invention is usable with currently available personal computers, mini-mainframes, servers and the like.

Computer system 6200 includes a bus 6202 or other communication mechanism for communicating information, and a processor 6204 coupled with the bus 6202 for processing information. Computer system 6200 also includes a main memory 6206, such as a random access memory (RAM) or other dynamic storage device, coupled to the bus 6202 for storing transaction and interaction data, and instructions to be executed by processor 6204. Main memory 6206 also may be used for storing temporary variables or other intermediate information during execution of instructions to be executed by processor 6204. Computer system 6200 further includes a read only memory (ROM) 6208 or other static storage device coupled to the bus 6202 for storing static information and instructions for the processor 6204. A storage device 6210, such as a magnetic disk or optical disk, is provided and coupled to the bus 6202 for storing transaction and interaction data, inventory data, orders data, and instructions.

Computer system 6200 may be coupled via the bus 6202 to a display 6212, such as a cathode ray tube (CRT) or a flat panel display, for displaying information to the user. An input device 6214, including alphanumeric and function keys, is coupled to the bus 6202 for communicating information and command selections to the processor 6204. Another type of user input device is cursor control 6216, such as a mouse, a trackball, or cursor direction keys for communicating direction information and command selections to processor 6204 and for controlling cursor movement on the display 6212. This input device typically has two degrees of freedom in two axes, a first axis (e.g., x) and a second axis (e.g., y) allowing the device to specify positions in a plane.

The invention is related to the use of computer system 6200, such as the illustrated system of FIG. 62, to access and manage information related to contracts, suppliers, and bids for business-related goods and services. According to one embodiment of the invention, the contracts and bids of a supplier are tracked by computer system 6200 in response to processor 6204 executing sequences of instructions contained in main memory 6206 in response to input received via input device 6214, cursor control 6216, or communication interface 6218. Such instructions may be read into main memory 6206 from another computer-readable medium, such as storage device 6210.

However, the computer-readable medium is not limited to devices such as storage device 6210. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 6206 causes the processor 6204 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 6200 also includes a communication interface 6218 coupled to the bus 6202. Communication interface 6208 provides two-way data communication as is known. For example, communication interface 6218 may be an integrated services digital network (ISDN) card, a digital subscriber line (DSL) card, or a modem to provide a data communication connection to a corresponding type of telephone line. As another example, communication interface 6218 may be a local area network (LAN) card to provide a data communication connection to a compatible LAN. Wireless links may also be implemented. In any such implementation, communication interface 6218 sends and receives electrical, electromagnetic or optical signals which carry digital data streams representing various types of information. Of particular note, the communications through interface 6218 may permit transmission or receipt of contract, supplier, and bid related information. For example, two or more computer systems 6200 may be networked together in a conventional manner with each using the communication interface 6218.

Network link 6220 typically provides data communication through one or more networks to other data devices. For example, network link 6220 may provide a connection through local network 6222 to a host computer 6224 or to data equipment operated by an Internet Service Provider (ISP) 6226. ISP 6226 in turn provides data communication services through the world wide packet data communication network now commonly referred to as the “Internet” 6228. Local network 6222 and Internet 6228 both use electrical, electromagnetic or optical signals which carry digital data streams. The signals through the various networks and the signals on network link 6220 and through communication interface 6218, which carry the digital data to and from computer system 6200, are exemplary forms of carrier waves transporting the information.

Computer system 6200 can send messages and receive data, including program code, through the network(s), network link 6220 and communication interface 6218. In the Internet example, a server 6230 might transmit a requested code for an application program through Internet 6228, ISP 6226, local network 6222 and communication interface 6218. In accordance with the invention, one such downloaded application provides for accessing and managing contract, bid, and supplier related information.

The received code may be executed by processor 6204 as it is received, and/or stored in storage device 6210, or other non-volatile storage for later execution. In this manner, computer system 6200 may obtain application code in the form of a carrier wave.

After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A computer-implemented method of managing procurement of a good or service for an enterprise comprising:
providing a centralized, network-accessible repository for supplier and contract information of the enterprise;
providing a mechanism for identifying suppliers in the supplier and contract information repository;
providing storage of financial information related to enterprise procurement;
providing a repository for supplier performance evaluation of suppliers in the supplier and contract information repository; and
providing a single interface for accessing the supplier and contract information repository, supplier identification mechanism, enterprise procurement-related financial information, and supplier performance evaluations.

2. The method as claimed in claim 1, further comprising the step of:
providing a mechanism for uniquely identifying goods or services; and
wherein the providing a single interface step includes providing an interface for accessing the unique identifier provided by the mechanism for uniquely identifying goods or services.

3. The method as claimed in claim 1, further comprising the step of:
providing a document repository accessible by the centralized, network-accessible repository; and
wherein the providing a single interface step includes providing an interface for accessing the document repository.

4. The method as claimed in claim 1, wherein the contract information includes existing supplier-related contract information, expired supplier-related contract information, and supplier-related bid information.

5. The method as claimed in claim 1, wherein the single interface provided is a browser-based interface.

6. The method as claimed in claim 1, wherein the providing a single interface step further comprises:
providing a total monetary value expended on a per supplier basis in response to a user query based on a supplier identifier from the supplier identification mechanism.

7. The method as claimed in claim 2, wherein the providing a single interface step further comprises:
providing a total monetary value expended on a per good or service basis in response to a user query based on a unique good or service identifier from the unique good or service identifier mechanism.

8. A computer-implemented enterprise-wide procurement system comprising:
a centralized, network-accessible repository for supplier and contract information of the enterprise;
a financial information repository connected to the centralized repository for providing financial information related to enterprise procurement;
a supplier performance evaluation repository connected to the centralized repository for providing performance evaluation of suppliers in the centralized repository; and
a user interface connected to the centralized repository for accessing information stored in the repository and the connected financial information repository and supplier performance evaluation repository.

9. The system as claimed in claim 1, wherein the centralized repository includes a unique identifier for each supplier and a unique identifier for goods and services of each supplier.

10. The system as claimed in claim 8, further comprising:
a document repository connected to the centralized repository for storing documents related to enterprise procurements.

11. The system as claimed in claim 8, wherein the contract information includes existing supplier-related contract information, expired supplier-related contract information, and supplier-related bid information.

12. The system as claimed in claim 8, wherein the user interface is a browser-based interface.

13. The system as claimed in claim 8, wherein the financial information repository includes a total monetary value expended on a per supplier basis based on a unique supplier identifier.

14. The system as claimed in claim 8, wherein the financial information repository includes a total monetary value expended on a per good or service basis based on a unique good or service identifier.

15. A computer-readable medium comprising:
at least one sequence of machine executable instructions for an integrated enterprise-wide procurement management system, wherein execution of the instructions by one or more processors causes the one or more processors to:
(A) provide a centralized, network-accessible repository for supplier and contract information of the enterprise;
(B) identify suppliers in the supplier and contract information repository;
(C) store financial information related to enterprise procurement;
(D) store supplier performance evaluation of suppliers in the supplier and contract information repository; and
(E) provide a single interface for accessing the supplier and contract information repository, supplier identification mechanism, enterprise procurement-related financial information, and supplier performance evaluations to a user.

16. The computer-readable medium as claimed in claim 15, further comprising instructions which, when executed by one or more processors, causes the one or more processors to uniquely identify goods or services of a supplier; and
wherein step E further includes providing an interface for accessing the unique goods or services identifier.

17. The computer-readable medium as claimed in claim 15, further comprising instructions which, when executed by one or more processors, causes the one or more processors to store documents related to enterprise procurement in a document repository.

18. The computer-readable medium as claimed in claim 15, wherein the interface provided in step E is a browser-based interface.

19. The computer-readable medium as claimed in claim 15, further comprising instructions which, when executed by one or more processors, causes the one or more processors to calculate a total monetary value expended on a per supplier basis in response to a user query based on a supplier identifier.

20. The computer-readable medium as claimed in claim 16, further comprising instructions which, when executed by one or more processors, causes the one or more processors to calculate a total monetary value expended on a unique good or service basis in response to a user query based on a unique good or service identifier.
